(19) United States
(12) Patent Application Publication
(10) Pub. No.: US 2008/0263890 A1
(43) Pub. Date: Oct. 30, 2008

(54) Wood Heat Treating Method, a Plant for Carrying Out Said Method and Heat Treated Wood

(76) Inventor: Edmond-Pierre Picard, St-Sulpice de Favieres (FR)

Correspondence Address: LEYDIG VOIT & MAYER, LTD, 700 THIRTEENTH ST. NW, SUITE 300, WASHINGTON, DC, 20005-3960, US

(21) Appl. No.: 11/910,677

(22) PCT Filed: Apr. 3, 2006
(86) PCT No.: PCT/FR06/00725

§ 371 Date: Apr. 29, 2008

(30) Foreign Application Priority Data
Apr. 4, 2005 (FR) 05 03300

(51) Int. Cl. F26B 5/04

(52) U.S. Cl. 34/282; 34/92

(57) ABSTRACT

A wood heat-treating method, a plant for carrying out the method, and the heat-treated wood. The heat-treating method consists in bringing each wood piece of a treatable lot into contact with a temperature controlled conductive press, whose temperature is accurately controllable in time and in intensity. The pieces are heated to or held at a desired temperature by any heat control for treatment and the wood is conductively heated to maintain the temperature and to cool the wood.

The invention relates to a wood heat treating method, an installation for carrying out the method, and to heat-treated wood.

Solid wood as well as reconstituted wood, consisting, for example, of agglomerated or compressed fibers or particles, present disadvantageous properties, such as, for example, hydrophilic character, dimensional instability, and the tendency to rot at varying rates.

When storing wood on brackets that has been freshly cut into boards or any other elongated product having predetermined dimensions, even if the wood has been dried, the above properties result in visible changes during storage that affect principally the dimensions and the shape of these products. Thus, for example, some initially parallelepiped shaped pieces warp, or other pieces shrink and crack. Reconstituted wood, in addition, tends to disintegrate.

To prevent such changes, the wood is generally treated according to different methods using the action of temperature, or a combined action, in a given chemical environment, of temperature and pressure or low pressure in the treatment enclosure:
to be dried
to be twisted or to cause the fragrances of the wood to come out (the work on casks by cask makers)
to allow the absorption of chemical additives (particularly for treatments in autoclaves)
to carry out heat modification of wood at high temperature, i.e., a modification of the ligneous material of the wood by means of a principal action of high-temperature heat applied to the wood
=in a gas flow that heats the wood pieces by convection in the presence of water, air, oxygen-depleted air and air that has been enriched with its principal natural constituents—nitrogen, carbon dioxide or water—(air in the natural state consisting of 80% nitrogen and 20% oxygen plus a large variable part of water and carbon oxides CO or CO2) or
=by immersing the wood in one or more successive baths of a liquid or a fragmented substance with an appropriate granulometry (silica sand or sand made of another material, metallic, for example), where this liquid or sand has the effect of transferring heat to the wood by conduction, and optionally the effect of causing the penetration (unintentional or intentional) of a chemical additive.

Heat treatment of wood at high temperature, under an inert atmosphere to prevent combustion, is a routinely used method. By heating the wood in an inert atmosphere up to a temperature of 150-280° C., the wood undergoes a transformation of its constitutive molecules as a function, on the one hand, of the used temperature curves, and, on the other hand, of the medium in which the wood is during the treatment. Some macromolecules of wood are broken down and combine mutually by crosslinking. Thus, polymerization takes place, and the properties of the wood are transformed.

The document FR-A-2 604 942 describes a method for manufacturing a ligno-cellulose material by heat treatment and a material obtained by this method. This method improves the behavior of the wood, when it is subjected to moisture content; it also produces a more or less pronounced, and homogeneous, improvement of the resistance of its mass to rotting (resistance to pathogens and to lignivores that usually attack wood in wet environments), a better dimensional stability with a modification of the wood's wettability, a transformation of its hydrophilic character into a relatively hydrophobic character, with a definitive and homogeneous coloration of the wood in its mass, and finally, with an increase in its surface hardness. In addition, this treatment makes it possible to eliminate later the coloration effects due to attacks by fungi that cause bluing or reddening of certain wood varieties.

On the other hand, this treatment induces a mechanical embrittlement, particularly bending rupture, which induces a more brittle character ranging possibly from a very slight decrease in performance to a determining embrittlement making this treated wood unsuitable for special uses in a number of wood applications, particularly for structural applications. In addition, if the temperature increases slightly above a certain limit, the degradation of the lignin worsens, the cellulose fibers break down in turn, and the wood finally loses all its mechanical properties rapidly.

Moreover, the presence of oxygen is a factor in the decreased possibility of improving wood qualities and in the degradation of its mechanical properties; the presence of water is another pertinent factor, since hydrolysis partially replaces the thermolysis of the wood, so that wood treated with steam in the flow of air is in principle less stable, less imputrescible and more brittle than wood treated with nitrogen. On the other hand, because nitrogen is a poor heat conductor, enriching air with nitrogen makes the heat transfer from the gas flow to the wood to be heated particularly difficult.

Another difficulty in the heat treatment of wood consists in successfully treating all the wood from the external edge to the core. Indeed, to treat a wood piece to the core, and in a homogeneous and optimal way, and to prevent the wood from cracking during the treatment, one must successfully reach the high temperature at which the crosslinking of lignin is achieved, which confers to the wood remarkable qualities, without exceeding that temperature, to prevent the wood from losing its mechanical properties.

On this subject, the document FR-A-2 751 579 describes a method for treating wood at the glass transition stage, which requires a temperature curve that has a temperature plateau corresponding to the glass transition temperature, independently of the means for transferring heat, and of the medium making the wood inert to prevent its combustion, which is spontaneous in air at temperatures above 100° C. An advantageous property obtained by this method is the crosslinking of the cellulose fiber; that is, chemical bridging (covalent bonds) between the macromolecular chains of the constituents of the material. To prevent the wood from igniting during the high-temperature heat treatment, the atmosphere is rendered inert with nitrogen, by replacing the oxygen, or with carbon dioxide, or by saturating the air with steam, or, finally, by “fritting” the wood in hot oil.

These measures, in the end, define three treatment variants:
crosslinking with a flow of air that has been rendered inert with nitrogen (method of the company New Option Wood; FR-A-2 751 579 and EP-0 880 429),
use of a flow of air that has been rendered inert with carbon dioxide, allowing the astute use of the oxygen in the air of the enclosure of a furnace for the combustion to heat the furnace, simultaneously depleting the air of oxygen and enriching it with carbon dioxide resulting from its combustion (method of the association A.R.M.I.N.E.S.; FR-2 604 942), and
high-temperature heat treatment by means of a flow of air in the presence of steam (the thermowood method of the company Valtion Teknillinen Tutkimuskeskus; EP-0 695 408).

Besides these treatments, methods for modifying the ligneous material including crosslinking lignin by immersion of the wood in liquid or sandy baths are known on a theoretical level, and they can be considered; however, at this time, in the state of the art, there is no known functional method, much less an industrial method. A method for immersion in hot oil is difficult to develop, and it appears that it has not produced treated wood whose qualities are recognized, while in addition creating the problem of an oily wood: these woods that have been impregnated with heated oils and thus degraded are no longer additive-free woods and over time they release a potentially polluting oil. Moreover, they are not appropriate for finishes, such as painting, for example. This environmentally unfriendly and additive-impregnated wood has at this time not demonstrated its qualities, and consequently it remains merely a theoretical possibility even today.

The above-mentioned crosslinking can occur in two ways:
crosslinking without a temperature plateau at the glass transition temperature; it takes place, as defined in the patent FR 2 604 942, at 240-300° C. to obtain the maximum effect in terms of dimensional stability and imputrescibility;
crosslinking at a temperature plateau corresponding to the glass transition temperature; it takes place, in practice, at 230-245° C. with a plateau at the glass transition temperature to obtain a compromise between the improvement in dimensional stability and hydrophobic character and the maintenance of a certain mechanical property of the treated materials.

The limits of the crosslinking method in terms of performance of the material obtained are related to the sensitive character of the performance curves of the different parameters that must be considered simultaneously, where each of these parameters evolves according to accentuated and non-monotonic curves, with discontinuities and maxima that are not in phase from one parameter to the other in a zone. All this occurs in an extremely narrow temperature range, while the crosslinking, as it is carried out, is managed with a coarse control instrument:
because of double thermal inertia of the known methods, on the one hand,
and, on the other hand, due to the fact that the classic crosslinking starts at 240° C., and
lastly due to the fact that crosslinking influences only the curve of the single parameter of temperature with respect to time, once the furnace type has been chosen.

Indeed, it is only by analyzing the thermolysis process that one begins to understand why the properties do not vary monotonically. Without going into the complicated and still mysterious detail of the different chemical modifications that occur in the thermolysis of the wood, one can summarize what occurs when the temperature is raised.

In the context of crosslinking, one often talks of controlled pyrolysis, but it would be more correct to speak of a controlled thermolysis, because the reactions do not take place due to the effect of the fire, but in the absence of oxygen due to the effect of heat.

However, it is known that wood is a composite material consisting essentially of three polymer types: hemicelluloses, lignins and cellulose, from the most fragile to the most sensitive to the effect of the temperature. A controlled thermolysis cleaves primarily the hemicelluloses and it starts to modify the lignin. The by-products of the thermolysis, essentially free radicals, then condense and polymerize on the lignin chains, and it is known that these reactions create a new lignin, called “pseudo-lignin,” which is more hydrophobic and more rigid than the initial lignin. Because the wood becomes hydrophobic, its dimensional stability is improved, which is reflected in an increase in antishrink efficiency (ASE) and in a lowering of the fiber saturation point (FSP). These improvements, due to the reduction of the active hydroxy sites, depend on the species that is being treated, and on the temperatures (FSP 12% for pine wood, for example, and approximately 30% for natural wood).

When the temperature increases, two events result: the molecular agitation leads to the most fragile chains breaking at the weakest places and, on the other hand, to the free molecules reaching an equilibrium and “sweeping the space” as soon as the glass transition temperature is exceeded. Thus, the heat starts cleaving the hemicelluloses, which has a positive effect on the hygroscopic nature of the wood, because it eliminates the sites that provide access to the bipolar water molecule. However, at the same time, this makes the wood fragile by breaking some hemicellulose fibers, and then almost all the hemicellulose; however, these fibers (which do not belong to the crystalline matrix of the wood, which consists of cellulose) present much lower mechanical performances than the lignins, and in the end they do not play a great role in the overall mechanical performance of the wood. The low exothermicity of these reactions shows that they start at approximately 200° C. Indeed, the exothermicity of the reaction starts at approximately 200° C. for deciduous wood and approximately 220° C. for coniferous wood, but this exothermicity remains low up to approximately 250° C. Then, when the temperature increases, a strong discontinuity occurs showing that the loss of hygroscopic properties has definitively occurred at approximately 225° C. It is generally recognized that the reactions of modification of the hemicelluloses by decarboxylation, and of the lignin by thermocondensation, are the probable cause of this hydrophobicity.

As the heat continues to increase after having started to cleave the hemicellulose, it is indeed the turn of the lignin molecules which also play a non-negligible role in the mechanical performance of wood, and this destruction of lignin results first in a deterioration of the mechanical properties of the wood. Then, a part of the free radicals originating from the hemicelluloses will encounter free chain ends of lignin which “sweep the space” or “wave their chain ends like arms.” At the same time, some ends break, rendering the wood fragile, while others combine with each other by crosslinking, which makes the wood more solid. These crosslinking operations produce indeed a modified “pseudo-lignin,” which is connected by covalent bridges to broken hemicellulose molecules, and these new molecules are stronger and better performing than the former starting molecules; the simultaneous race between destruction and construction with a kinetics that depends on numerous factors leads on average to an improvement to start with, when one increases the temperature slightly and maintains it for a short time. However, for a given temperature, construction predominates at the beginning and then runs out, while the destruction continues. If, on the other hand, one increases the temperature too much, the destruction events are amplified and they take precedence over the construction kinetics.

Beyond 250° C., the exothermicity becomes very high, and the cellulose is attacked, so that the wood in a very short time loses a large part of its mechanical performance.

In a first gross approximation, one can thus see that it is advantageous to stop the treatment above 225° C. and below 250° C.

An example will illustrate the problem more finely. The published scientific studies show, in the examples studied, namely the maritime pine, the evolution of 3 fundamental parameters: the improvement of the ASE dimensional stability (in %), the improvement of the resistance to fungal biodegradation EBIO (in %), and the mechanical loss (in %) when one subjects wood for a duration of 5 min to a temperature of 230, 240, 250 or 260° C.

The following percentages are obtained, respectively:

| | ASE % | EBIO % | Mechanical loss % |
|---|---|---|---|
| <150° C. | 0 | 0 | 0 |
| 230° C. | 17.7 | 36.6 | 10.9 |
| 240° C. | 25.1 | 43 | 7.6 |
| 250° C. | 32.2 | 92.6 | 45.3 |
| 260° C. | 30.1 | 91.8 | 50 |

One notes that the mechanical loss goes through a first maximum before 240° C., probably between 230 and 240° C., and a minimum between 230 and 250° C., probably close to 240° C., with a very abrupt deterioration after the minimum.

On the other hand, one observes that the ASE and EBIO increase between 230 and 240° C., and continue to increase to approximately 250° C. after which they slowly decrease between 250 and 260° C.

The ASE changes little from 240 to 250° C., but it is also known from the scientific studies that the treatment has a negative effect on the dimensional stability of pine at temperatures below 230° C., while at higher temperatures the monotonic improvement against shrinkage, which is visible in the table above, is proportional to the evolution of the parameters of temperature and heat treatment duration up to (250° C., 15 min). Past this pair of parameters (temperature, duration of exposure), the improvement is no longer detectable, and the mechanical properties are degraded.

EBIO, for its part, undergoes a very large improvement between 240 and 250° C.

Using this criterion alone, it would be tempting a priori to increase the temperature to 250° C., whereas the criterion of mechanical loss leads one to stop at 240° C. There is a conflict of interest between the four data.

| | EBIO % | Mechanical loss % |
|---|---|---|
| 240° | 43% | 7.6% |
| 250° | 92.6% | 45.3% |

These results from a simple example illustrate the problems of different non-monotonic parameters whose maxima are not in phase, and whose variations are rapid in a small temperature range. At 10° C. separation, for 5 min, the effectiveness of the biological resistance is multiplied by 2, while the mechanical properties drop, with the losses being multiplied by a factor of 6.

Thus, between 230 and 250° C., one can see the parameters move within broad ranges, very rapidly and not in phase, and a theoretical compromise has to be found, with a sufficiently fine control to achieve what is desired.

By varying the duration of exposure at a given temperature, the temperatures of the maxima evolve downward when one increases the exposure time, but the effect of the exposure time does not cause a change in the maxima of the parameters in the same way and at the same speed; therefore, it is possible to vary only the duration of exposure to reduce the temperature range of the parameters to find in the end a pair of parameters (maximum temperature, duration of exposure) which optimizes the result as a function of the desired objective.

In addition, the phenomenon of mechanical losses is simplified here by an average number of mechanical losses, while the wood is in fact an anisotropic material, which requires a much finer analysis of the mechanical behavior after thermolysis, and finally leads to an increase in the degree of complexity of the variables to be examined.

Indeed, one usually says simply that the thermolysis has a three-fold mechanical effect on wood:
a beneficial effect on hardness of the deciduous woods, which increases the denser the deciduous wood is, and the hardness is unchanged or slightly decreased for coniferous woods
a neutral effect on behavior under compression, provided that the cellulose is not affected (around 250° C., degradation may start, and after that temperature it becomes very exothermic and the destruction is very rapid), and
a partially positive effect with an increase in the rigidity, which, however, is negative because this rigidity is accompanied by an evolution from a visco-elastic behavior to a fragile behavior. Conventionally, this effect of the thermolysis on the wood is summarized as an increase in Young's modulus which affects primarily the resistance to rupture and the maximum work before bending rupture.

Ignoring the two first positive mechanical properties, the mechanical loss considered in general and in the example of the maritime pine given above concerns thus essentially the resistance to bending rupture.

A singularly complicating factor in the search for an optimum is the fact that wood is highly anisotropic because of the manner in which trees grow, and the fact that there are three orthotropic directions (direction of the fibers in the direction of the height of the tree, direction of the core at the bark of the tree, and lines that are tangential to the growth circles) which determine three different orthotropic Young's moduli and which, above all, have non-monotonic curves depending on the maximum temperature. These curves do not have their maxima at the same temperatures, and these parameters vary quite rapidly in narrow temperature ranges.

Thus, it is necessary to determine for each wood type and for each intended type of use of the wood an optimum pair of parameters (maximum temperature, time of exposure), and this optimum must be respected very precisely.

Thus, the extreme rapidity of the variations in the properties of wood subjected to thermolysis makes it very necessary to develop a novel method to continue to improve these properties, because the methods that are generally used “run into” two obstacles:
greater precision is required in the temperature and the duration of exposure, but the methods known in the state of the art are incapable of increasing further the precision of the treatment because of a double thermal inertia between the heat-conducting gas flow and the edge of the wood piece by convection, on the one hand, and from the edge of the wood to the core of the wood by internal conduction, on the other hand: these inertias are such that the temperature and duration of exposure are poorly controllable
the known methods vary only the temperature curve, while other parameters would allow a better control of the thermolysis of the wood.

In reality, the known methods also vary the chemical environment with the options of an atmosphere that has been rendered inert with nitrogen, water or carbon dioxide.

However, it is known that the presence of an oxidant accelerates the reactions of degradation of the material. The inert or slightly reducing atmosphere promotes the control of the treatment cycle. In a humid atmosphere under steam, the hydrolysis reactions are superposed over the pyrolysis reactions proper. Therefore, one should avoid the use of an atmosphere which has been rendered inert (hereafter also referred to as an “inert atmosphere”) with steam, if the intention is to improve the known properties of the thermolyzed woods. However, the chemical environment specific for each method is then a constant which no longer intervenes, and thus one can vary only the temperatures.

Other aspects concerning the methods that are generally used and their drawbacks are evoked below in a random order and without connection to the importance that they may have.

The methods for treating wood at high temperature that are generally used concern simultaneously:
theoretical temperature curves, from which one cannot deviate without strongly alternating the compromise between the improvement at the core of the imputrescibility and the stability of the wood and the small decrease in its mechanical properties, and
the type of treatment methods:

by gaseous convection in an enclosure that is inert due to oxygen depletion with carbon dioxide or with nitrogen or with steam,

by immersion in baths (even if there is no industrial method for this procedure which continues the heat treatment up to the crosslinking curves of lignin).

The different heat treatments used share a certain number of properties, including

stacking with the help of brackets,

phases of transformation of the wood during the course of the thermal cycle, and

cooling by injection and vaporization of water.

The different installations used to carry out the heat treatment of wood share the fact that they comprise brackets that make it possible to stack the pieces to be treated leaving sufficient space for the passage of the gaseous or liquid flow. Indeed, the property that is shared by the two principal known methods is the treatment of the wood which has been placed in an enclosure in which a ventilation system causes strong flows of heated gas to circulate on the surface of the wood and thus transports by convection heat until it comes in contact with the wood, and the transfer of heat occurs between a flow in movement and the surface of the wood.

Since the gaseous flow must circulate on the surface of the wood, the surface of the wood must be free or uncovered. Therefore, one cannot place the boards of wood one on top of the other: one must have stacks of boards (or round wood pieces) whose two faces are in contact with the flow thanks to the brackets that separate two consecutive boards to leave sufficient space between them to allow a good passage of the flow. Instead of boards that are separated from each other, it is also possible to use groups of boards that are placed directly on each other, but these groups are the equivalent of individual boards and they are separated from each other by brackets that separate the first board of a group from the last board of the preceding group. The brackets (wood racks or hollow metal tubes) perturb the flow in the vicinity of the obstacle, and this flow does not contact the wood at the level of the racks, which are often made of metal to transmit to the support surface a heat which is close to that of the gaseous current. They must necessarily be separated sufficiently so that they do not perturb the gas flow excessively, and they have to be close enough to prevent the wood from bending between the racks.

Another shared characteristic is the temperature cycle, which starts at ambient temperature and returns to it, passing necessarily during the course of the cycle through the six phases of transformation of the wood which are explained succinctly below:

### 1st Phase: Drying

When a wood piece is introduced into a furnace to be heated, this wood piece always contains a certain quantity of water; the water is present in a varying quantity and in a more or less free or bound form, ranging from water that flows freely to constitutive water.

Indeed, water can be present in wood in three different situations, as free water, bound water, and constitutive water.

Free water is the water present in the wood, which itself consists of the juxtaposition of micro “tubules,” oriented in the direction of the fiber of the wood. The interior of these tubules constitutes the porosity of the wood, and water can circulate relatively free in them, as between sand grains. For information, the percentage of moisture content, i.e., the ratio of the total weight of the water to the weight of completely dry wood can reach 100-200% when the porosity of the wood is saturated with water, and approximately 30%, at the fiber saturation point (FSP), when this macro-porosity volume is empty. As would be the case with pure sand, wood does not swell when this macro-porosity volume is drained or filled. The heated water is present in the form of liquid and vapor.

Bound water is the water present in the walls of the micro-tubules which also present an internal porosity, whose magnitude is however much lower, resulting in a preponderance of forces that are connected with the surface tension. The walls of the micro-tubules behave with respect to bound water as clay would, for the same reasons connected to the magnitude of the porosity. Because the walls are swollen at a maximum when there is water or moist air inside the micro-porosity volume formed by the interior of the tubules, this micro-porosity is “crushed” by the swelling of the walls; for this reason, the bound water circulates in a reduced micro-porosity because of this swelling and thus encounters a relatively strong resistance to flow, as would the porosity in clay. This bound water is drained and filled to be in equilibrium with the vapor pressure of the ambient air, and this is the reason why wood swells and contracts naturally in air having a moisture content whose percentage varies between a minimum of 5% and 14-30% in general.

Constitutive water is the water that is part of the cells themselves, as in any living tissue and that cannot be extracted by reversible drying without breaking the cell.

The first action of heat is to dry the wood; that is, to evacuate the water contained in the wood, starting, for example, with all the free water, and then with all the bound water, leaving the constitutive water in the cells. Indeed, this action occurs in two movements generated by two distinct forces.

The first movement consists of the migration of water from the interior to the exterior of the wood due to the effect of the increase in temperature inside the wood. To leave the wood, the water present inside the wood must first migrate from the core to the surface of the wood. This migration of water inside the wood occurs due to the effect of the heat which increases the pressure of the gas present in the porosity volume. If it is known that the moisture content can reach, for example, 200%, and it is assumed that the moisture content is 150% at a given time, this means that a quantity of water representing 50% of the weight of the wood has left the wood and been replaced with air (or ambient gas). If the wood is heated, the air can dilate inside the porosity volume of the wood and exert pressure on the water (according to the classic formula for perfect gases PV=NRT, which means that the pressure of the fixed quantity of gas increases with the temperature and decreases with the available volume; however, the water itself will create an additional quantity of gas as it is heated since the saturating vapor pressure increases with temperature: this means that the rising temperature generates pressure both as a result of the law of perfect gases in a constant volume of porosity that is not occupied by water, and by the increase in the quantity of gas in this porosity due to the evaporation or boiling of the water. For example, if the pressure at the level of the surface is atmospheric pressure, lower than this pressure inside the volume of the wood, and higher, as observed, due to the increase in temperature, generates a movement from the interior to the exterior, which is limited internally by the resistances to circulation, which are connected to the porosity (Darcy's laws), and, once the surface is reached, by surface tension forces that prevent water from “flowing” (except a little bit at the longitudinal ends), but keep it on the surface of the wood, from which it can essentially not escape except by evaporation.

The second movement is the evacuation of the surface outside of the wood by evaporation, which is connected with low pressure, high pressure, and the low level of saturation with water of the ambient air: Water on the surface can be evacuated by evaporation. The evaporation kinetics are more powerful the farther the air of the surface is from being saturated with water. However, air (or any other gas) can contain more water if it is hotter and if the pressure of the air is lower; and evaporation takes place as long as the quantity of water in the gas is lower than the quantity that it can contain, and the evaporation is more rapid the farther one is from saturation.

This drying operation is very endothermic because, in addition to the energy required to heat the wood and the water that it contains, (in fact, one could refer to the process as heating the wood by the water that it contains), energy is needed above all to evaporate this water (latent heat of transformation).

This operation is particularly very delicate in the sense that, if one tries to accelerate the process, the water pressure risks bursting the wood (phenomenon of wood collapse during drying), particularly with certain woods, such as oak, in the phase of drying with supersaturation, i.e., when the macro-porosity volume is still relatively filled with free water. The collapse is due to the excess vapor pressure and, apparently, an embrittlement of the walls with the temperature increase.

Finally, it is paradoxically more difficult to dry a dry wood than a wet wood, because the water contained in the wood conducts heat, while the wood itself is highly insulating. One must avoid intense evaporation at the surface, which creates a thermal insulation of the wood, makes the transmission of heat difficult, and thus the transfer of the heat required for evacuating the water. For this reason, the wood is wetted, and one often dries it by starting with a first phase conducted in a water-saturated atmosphere to prevent the evaporation, until the overall temperature of the wood has been raised.

### 2nd Phase: Elevation of the Temperature of the Wood

By continuing to heat the dry wood, the temperature of the wood increases; this is a simple endothermic operation: the heat is transformed into an increase in the temperature as a function of the heat capacity of the wood. If the operation is conducted in air, the wood would ignite spontaneously starting at a certain temperature due to the action of the vibrations of the molecules of wood in the presence of oxygen.

3rd Phase: Entry into the Glass Phase

As the temperature increases, the wood reaches the so-called glass phase, starting at a temperature Tg called glass transition temperature, from which temperature onward the wood loses its rigidity and becomes malleable. The complexity of the molecules, together with the molecular agitation which is heat, causes the wood to reach an intermediate rheology between solid and liquid. It is a second-order transition, without latent heat of transformation, as in the case of melting, but with an increase in the heat capacity and particularly the malleability of the wood, which becomes plastic and will preserve the acquired phase in the glass form, when the temperature falls again below it.

In reality, the wood consists of numerous fibrous macromolecules which each have a different glass transition temperature, which increases with the length of the fibers, so that the wood becomes increasingly malleable at temperatures above 150° C. up to 200° C.

At this stage, the wood gradually becomes colored in the mass with a homogeneous hue, which becomes darker as the temperature rises.

### 4th Phase: Fracture of the Hemicellulose and Lignin Macromolecules

By increasing the temperature further, the molecular agitation also increases further until the more fragile molecules can no longer be shaken without breaking: this is how the hemicelluloses are broken into relatively small pieces, and the lignins into relatively larger pieces, while the cellulose is not affected. By breaking these pieces, internal energy is released, and the event releases heat: the exothermic phase is reached.

### 5th Phase: Crosslinking

As soon as the temperature rises by a few more degrees, the hemicellulose pieces that have broken chemical bonds come to be assembled with the lignins by crosslinking to form a three-dimensional molecular network.

An optimum compromise exists between the improvement of the performance in terms of imputrescibility and dimensional stability, and the mechanical degradation at the beginning of the fracture of the lignins, which is compensated by the crosslinking and then degrades increasingly, leading ultimately to degradation of the cellulose.

The polymer macromolecule obtained by crosslinking plays a role of “sealed jacket” and it confers a hydrophobic character on the wood. In addition, this crosslinking eliminates the most fragile points from the wood: the chemical bonds broken in phase 4 are in fact precisely the targets that are normally attacked by the enzymes of wood predator organisms (which logically choose the weakest chemical bonds to start their attack on the wood). These two combined causes (resistance to wood attacking enzymes and drying environment) confer on the wood its imputrescibility and its dimensional stability.

In addition, a new characteristic appears: the crosslinked wood has modified surface tension properties.

### 6th Phase: Lowering of the Temperature of the Wood

If kilogram-calories/hour are taken from the wood, its temperature decreases. The crosslinking that occurs is irreversible, and nothing special happens on the chemical level. On the other hand, the wood becomes rigid again below the glass transition temperature.

The third shared characteristic is the cooling procedure. Indeed, because the wood is modified thermally in the enclosure at a temperature of approximately 230° C., it must necessarily be cooled before its removal from the furnace, because it would ignite at temperatures above 100° C. The method that is generally used by the different methods is to incorporate water whose vaporization cools the wood.

Moreover, the different procedures used to date present a certain number of drawbacks, which limit profitability and can slow and limit the commercial development of thermomodified woods as they make it impossible to purchase less expensive woods, such as certain agglomerated panels which bend and undergo mechanical disintegration between the racks.

Thus, it is not possible to treat stacks of different thicknesses, in spite of the fact that it would be advantageous to create undifferentiated stocks of varying heights in flitches, which would provide the advantage of having wood that has been cut ideally, along the direction of the fiber.

One also cannot treat several stacks that have been introduced into the same enclosure, using individual heating curves as a function of the nature of the wood. For this purpose, it would be necessary to develop at least separate heating curves and to find means that allow, within the same enclosure, the connection of tubes that can be regulated layer by layer.

When treating reconstituted woods, which may be plywood, agglomerated wood, medium-density fiberboard or other types of panels, the glues used can evolve noxious gases (urea-based glues) or toxic gases, and such a treatment cannot be carried out with a gas convection furnace, which is not equipped to treat these gases, while in a vacuum enclosure everything is extracted and can be stored or treated.

The heat treatments of wood that were generally applied before the present invention, are similar in one particular regard: to treat the wood, the wood is placed in an enclosure in which a ventilation system causes a strong flow of heated gas to circulate on the surface of the wood, and thus transport the heat by convection to the contact point of the wood, and the transfer of heat occurs between a moving flow and the surface of the wood.

Since the gas flow must circulate on the surface of the wood, the surface of the wood must be “in the open air,” i.e., one cannot place the boards one on top of the other (or possibly two by two), instead they are placed on the racks (wood or metal brackets), which are sufficiently far apart from one another so as not to interfere with the gas flow and sufficiently close to one another to prevent the wood from bending between the racks. In any case, this constitutes a constraint (and requires work) to the extent that:
the air flow is necessarily perturbed in the vicinity of the obstacle and does not come in contact with the wood at the level of the rack, which is often made of metal to transmit a heat that is approximately identical to that of the gas flow to the support surface; careful examination of the wood often allows the visual detection of the effect of the battening;
this battening makes it impossible to apply a homogeneous mechanical pressure to the wood; on the contrary, the weight of the wood stack exerts a pressure only at the level of the racks, and this makes any crosslinking of the fragile panels of agglomerated wood, for example, impossible, because it buckles under the heat and creates waves between the racks.

The very principle of a furnace with a gas flow circulating between the stacked boards is very complex to conceive and implement, and it is very difficult to model the highly complex mechanisms involved in a representative way:
on the one hand, even if one can achieve an approximation, one cannot guarantee a gas circulation model that is homogeneous throughout the entire enclosure, in spite of a complicated apparatus for blowing, directing and recovering the gas. The larger the furnace is, the greater the tendency of the gases is, in actuality, to deviate from the dynamic model of the fluids, taking into account the turbulence, the roughness, the boundary layers which one cannot neglect since they are located precisely at the place of the exchanges and of the circulations that are modified by the density of the gas, again taking into account the temperature and the exchanges of moisture content. Incidentally, not only is it nearly impossible to guarantee in advance that the gas flow will have the dynamics predicted by the model, in addition, it is impossible to check the gas flow later by measurements of the air speed between the boards.
on the other hand, even if the flow of the gas were known, the heat exchange between the gas and the surface of the wood is very difficult to model: this exchange involves a gas of varying conductivity at a given temperature and moisture content, where it is known that these three variables vary between the beginning of the stack and the exit of the stack, taking into account the exchanges themselves. To prevent a large variation, one moves large gas flows, thus at high speed. However, this further increases the difficulty of the modeling, because speed implies turbulence. The gas flow can be better than the wood piece without succeeding in heating the surface, as long as water or volatile products escape from the wood. Indeed, the wood can remain for a long time at constant temperature, just like a person can remain for 1 h with his/her body at 37° C. in a sauna where the temperature of the air is 120° C., because the air causes the evaporation of perspiration, which cools the skin. While it is certain that experience has indeed shown that the crosslinking at 230° C. in the end takes place with a less dense wood, but only after having overcome the wood's mechanisms of regulation, depending on the available moisture content, and the exchange is at the same time slow, relatively costly, terribly complicated from the theoretical point of view, and, in the end, difficult to model and difficult to appreciate in its homogeneity. In addition, this mechanism does not allow the crosslinking—at least not in a profitable way—of wood pieces having thicknesses of 15 cm, 20 cm, or a fortiori more.

As long as there is water to evaporate, the heat flow delivered to the surface of the wood is perturbed by the evapotranspiration on the surface, if the gas is not at the saturation point, and thereafter, one risks having a very dry wood surface which does not correctly transmit heat, because uncompressed dry wood is an insulating material. While the wood still contains water, one can also imagine a scenario of correct and rapid transmission of the heat in the wood with water reaching the boiling point throughout the entire wood piece, followed by a brief drop in the surface temperature due to strong surface evaporation, which leads to the slowing of the evaporation of the water on the surface and, as a result, to the collapse in interior of the wood piece. Indeed, experience has shown that, particularly for deciduous wood, a relatively thick and relatively wet wood piece which has been heated too quickly can come out of the furnace completely collapsed.

In the case of heat treatment with air and steam, the presence of oxygen and water is detrimental to the quality of the treatment.

In regard to the usual industrial procedures for crosslinking or heat treatment at high temperature, the treated wood acquires new properties, as described above. But the required investments and costs of treatment result in a high cost price of the treatment. In addition, it is not possible to crosslink any size of wood, nor to exceed a certain level of technical quality.

Concerning the technical quality,
one faces an unsatisfactory compromise (50% improvement of the biological resistance with pine) with a very large standard deviation for the measurements of the results, notably in terms of mechanical losses (20-60%);
one cannot exceed a certain plateau of homogeneity of the treatment;
it is impossible to determine what the heat exchanges are in a given zone of the furnace, and even less possible to specify them independently; at best one can estimate, by modeling and approximation, that the exchanges are homogeneous in the furnace; in case of an incident that perturbs the passage of air in a zone of the furnace, it is impossible to know that this event occurred unless a discoloration (too light or too dark) leaves a trace of the event.
it is impossible to eliminate a certain quantity of oxygen or of oxidizing products from the gas flow;
it is impossible to avoid the effects of the heterogeneities of treatment, which result from the battening;
the air flow is necessarily perturbed in the vicinity of the obstacle and it does not come in contact with the wood at the level of the rod, which is often made of metal to transmit to the bearing surface a heat which is approximately identical to that of the gas flow; attentive examination of the wood often makes it possible to visually detect the effect of the battening, which creates discolorations;
this battening prevents the exertion of a homogeneous mechanical pressure on the wood, because weight of the stack of wood exerts pressure only at the level of the racks; this prohibits the crosslinking of fragile panels of agglomerated wood, for example, because the wood buckles under the heat and becomes wavy between the racks;
there is no known procedure for treating small wood pieces, because of the difficulty of creating a stable stacking without impeding the flow of air;
the risk of collapse is high, particularly with deciduous wood and thick boards requiring a long time.
   As far as profitability is concerned,
one cannot improve the profitability by a more rapid treatment;
one cannot exceed a certain thickness of wood in a cost-effective manner;
because, in the same furnace, one cannot use two different treatments simultaneously (different species or thicknesses) and this raises a problem of profitability because, moreover, the furnaces are expensive and must be of large volume and filled with each “charge” to become profitable;
the use of nitrogen represents a non-negligible variable cost;
the energy losses are considerable, since one does not recover, during the cooling, the energy required for the temperature rise.

In the state of the art, the treatment at the glass transition temperature has in fact two objectives:
the first objective of the heat treatment at the glass transition temperature in the state of the art is to avoid the external edge of a wood piece potentially having a temperature that exceeds the glass transition temperature while the core has not yet reached that temperature. The danger is that the wood becomes increasingly plastic and malleable above this glass transition temperature at the edge of the piece, while another part would remain hard in the core of the piece, which has not yet reached this temperature; in the absence of a mechanical stress, this can release stresses on the exterior of the piece while the core remains rigid, and thus cause splits and cracks in the wood, due to the difference between the wood that is moving at the edge and the wood that is immobile in the core.
Moreover, a second objective of the heat treatment at the glass transition temperature in the state of the art is to allow advantageously the temperature of the core of the wood to catch up with the temperature of the edge, because the heat of the gas flow takes a long time to be transmitted to the edge of the board, and the core is far behind compared to the edge: there is a double thermal inertia; this double inertia is a severe handicap in controlling the temperature between 230° C. and 240° C., when one already has to cool the edge which has completed its time at high temperature, while the core has not yet reached that temperature. The worst possibility, when all the heat or cold come from the exterior, is a situation where one still needs to heat the interior when the exterior already has to be cooled. The only solution is to approach the high temperatures at a small temperature gradient in the interior of the wood to maintain control in spite of the double inertia. The temperature plateau at 170° C. or 180° C. corresponding to the glass transition is thus very useful to achieve a uniform temperature of the wood at a temperature which is not too far from the crosslinking temperature.

Besides the treatment of the new wood, whose difficulties and drawbacks in the procedures that are generally used have already been described above, it could be of interest to examine whether old woods could also benefit from an improved treatment.

Indeed, on the economic level, one of the most interesting possibilities would be to be able to treat polluted woods, such as, for example, creosote-treated railroad ties, which have been delignified and present a large available volume of dry wood which is of good quality and can be bought at a negative price, because this wood is waste material that must be subjected to a pollutant-removing treatment at the end of its useful life: the treatment with creosote has preserved the ties in excellent condition, but makes them unusable today, because of the prohibitions of the new environmental standards.

According to the state of the art, it is not possible to treat woods that have been contaminated with chemical products, such as creosote, or chemical autoclave treatments with copper chromium arsenic (CCA).

The example of the pine resins in the state of the art illustrates this difficulty: the resin falls to the bottom of the tank, and one must scrape it for recovery, or heat this molasses which is not polluting, but it would be impossible to produce a product with a rheology that is close to the resin but polluting and dangerous to breathe in as vapors. The volatile parts mix with the heat flow: the recovery of viscous juices and of the volatile effluence is not possible in this state. In addition, no reliable circulation is provided between the enclosure and the tank.

Moreover, it is practically impossible, because it is economically not profitable, to store the cooling calories of a furnace to be used later for heating, because one would have to recover the calories which are not converted in temperature increase of the gas flow but stored in the form of latent energy of transformation of a humid gas. This recovery is impossible because it is too expensive, resulting in a nonoptimized variable energy cost, and in the context of a lasting development procedure, a loss of energy which would be regrettable from the environmental standpoint.

On the economic level, one is limited by the possibilities of transferring heat from the gas flow to the wood and to the core of the wood, which, in this state, makes the crosslinking of the wood over a thickness of 15 cm, 20 cm or more very difficult, if not impossible on the technical level, and in any case not likely to be considered on the economic level.

In addition, technically:
the more one increases the size of the furnace, the more one moves away from the flow model and the less homogeneous the flow is;
phenomenon of battening: qualitative yield problems; improvement very difficult, limited by the capacities of transmission of the heat-conducting gas fluid towards the woods. Objective: better cost effectiveness by a necessary, more rapid and more homogeneous transmission towards the wood.

To find a solution that makes it possible to overcome the different drawbacks mentioned above, an analysis of the methods that are generally used was carried out.

First, a theoretical analysis of the limits of the current procedures was carried out, since the current state of the art derives from a practical analysis, and continuation of the analysis promises to allow advances to be made. Therefore, it is necessary to analyze successively the three major constraints of crosslinking:
the theoretical causes of the temperature constraint leading to the current solution with a temperature plateau in the glass transition phase, and means to overcome it,
the problem of mechanical embrittlement and the means to compensate for it, or reverse it by mechanical reinforcement, and
the problem of obtaining a homogeneous treatment.

The analysis of the theoretical causes of the temperature constraint leads to the current solution with a temperature plateau in the glass transition phase and to means for overcoming it.

### Prior Theoretical Thinking

The difficulty of the treatment consists in controlling the temperature in an insulating fibrous material with a temperature that is to be reached everywhere, where this temperature generates a weak exothermic reaction and the risk of slightly exceeding the temperature to be reached; such an excess temperature would generate, on the one hand, a deterioration of the wood, and, on the other hand, a strong exothermic reaction.

If one considers the x axis to be the direction from the edge of the wood to the core of the wood, one gets the energy conservation equation for a time dt in a cylinder of length dx along the x axis and with the unit surface S, which can be written:

QCdxΔT=Q

where

Q is the density,

C the specific heat,

T the temperature, and

t the time.

Q is the heat energy, which is the sum of the entering and exiting heat flow and of the internal heat.

Q=−Kdx∂²T/∂²x+Q exothermicity+Q latent heat

The internal heat itself is the sum of the latent heat of the melting or evaporation transformation, and of the exothermic heat of the chemical reactions:

Q=−Kdxdt∂²T/∂²x+q exothermicity dxdt+q latent heat dx dt

where

q exothermicity and +q latent heat is the heat density per unit of time and of space

One derives Q C ΔT/dt=−K ∂²T/∂²x+q exothermicity+q latent heat,

which gives:

QC∂T/∂t=[−K∂²T/∂²x+q exothermicity] at high temperature

QC∂T/∂t=[−K∂²T/∂²x+q latent heat] in the drying phase

The second term of the above equation in the drying phase explains the unwanted temperature plateau (at 100° C. at atmospheric pressure, but at 40° C. in a vacuum), because all the heat is transformed into latent heat of transformation.

On the other hand, the glass transition phase is a 2^{nd}-order transformation and the coefficient C is increased when T reaches the glass transition temperature, but there is no latent transformation heat.

The first equation makes it possible to understand how the heat conduction makes it possible to control the temperature inside the wood when there is an exothermic reaction above 200° C.

What one clearly sees is that the temperature reaches an equilibrium at a given point if K ∂²T/∂²x=q exothermicity.

Thus, one understands that if the exothermic reaction is strong and the conductivity K is weak, it will be impossible to counterbalance the exothermicity, especially if the influence by diffusion of the heat-conducting fluid has itself a starting inertia: this is indeed the difficulty which one observes in practice with deciduous woods.

The thermal conductivity k is indeed very low in the crosslinking phase of wood (approximately 230° C.), because dry wood is a very poor heat conductor; however, crosslinking occurs with completely dry wood: there is no water left in the pore space, and at these temperatures only constitutive water remains.

The experience of crosslinking under nitrogen also shows that the temperature difference between the temperature that must be reached and the temperature that should not be reached is very small: using the example of a deciduous tree such as beech, the T_{crosslinking} temperature to be reached is 235° C. for more than 30′, and it is known that water must be injected in a quantity sufficient to block the exothermicity if the wood does not remain at the nominal value of 235° C. but undergoes a temperature increase up to 242° C., where a new exothermicity phase is located, as it is known that the wood is lost if it reaches the T_{prohibited} temperature of 250° C., or even 245° C., which occurs sometimes.

Heat diffusion left to itself, without chemical reaction, obeys the equation

QC∂T/∂t=[−K∂²T/∂²x].

This diffusion depends on two factors: K, and the heat transmission conditions of the heat-conducting medium on the surface of the wood.

Thus, one understands that the system is controlled thanks to the coefficient K and that it would be much easier to control if K were larger.

If one considers the temperature plateau at the glass transition temperature, this plateau has three causes:

three reasons for existing:
a long time to diffuse the temperature into the wood
a long time to cause the heat of the heat-conducting gas to move towards the edge of the wood
a risk of the wood “moving” in the absence of the stress to clamp it, due to internal stresses of the part is rigid (temperature below the glass temperature) and the other part flexible (temperature above the glass temperature), with relaxation of stresses, which are greater the further the temperature moves from the glass transition.

Therefore, a means would have to be found to decrease the duration of the heat diffusion from the environment outside of the wood and to decrease the equilibration time inside the wood, and a means to mechanically constrain the wood to prevent the splits and cracks that accompany the differential relaxation of the internal stresses of the wood.

The major problem of the treatment was a weakening of the mechanical performances of the wood: this weakening can be reduced to a minimum, and it can be compensated, and, even better, one could improve these properties by a means which allows the compaction of the wood and the improvement of the precision of the pair of parameters (maximum temperature, duration of exposure).

The analysis shows that the destruction of the lignin fibers is responsible for a loss in performance, which is compensated to varying degrees by the creation of a pseudo-lignin, depending on the appropriateness and the precision of the pair of parameters (maximum temperature, duration of exposure) applied to the wood. A theoretical solution consists in decreasing the thermal inertia and in varying the other parameters that influence the thermolysis.

The analysis has shown that pseudo-lignin is more rigid and thus more brittle than lignin remains a characteristic of wood treated by thermolysis; however, if one accepts a greater rigidity compensated by a greater resistance during bending, and if one accepts that the material can be more rigid and brittle, but have greater resistance before bending rupture, one solution would consist in increasing the number of fibers per volume of wood, which can be achieved by compacting the wood, according to the invention, as will be seen below.

The analysis shows that one of the reasons for the temperature plateau at the temperature Tg is to reduce the gradient: the solution is to decrease the thermal inertia and to add heat directly to the mass. The other reason is to avoid cracking the wood due to the release of stresses; one solution would be to constrain the wood to prevent it from releasing its stresses above the glass transition temperature.

### Analysis of the Problem of Mechanical Embrittlement and of the Means to Compensate for it by a Mechanical Reinforcement (Compaction)

Analysis of the problem of homogeneity: T is a cumulative value, which integrates the history (and accumulates all the heterogeneities). The fact that T is a cumulative value means that all the differences in heat flow are integrated over the duration of the treatment and lead to differences, which may be large due to the weak conduction which does not allow compensation by internal distribution. The theoretical solution is to simultaneously avoid the heterogeneity of the thermal flows in the lot to be treated and the increase in the internal conductivity.

To the extent that convection is a source of differences in mechanical and thermal flow with an influence on the moisture content in the wood and in the gas flow, one would have to overcome these causes of heterogeneity.

Thus, the theoretical study shows that all the problems that limit the quality of the treatment are connected to a double thermal inertia and would be improved particularly if one could increase the internal conductivity K, increase the heat transfer between the exterior and the wood, decrease the heterogeneity of addition of heat to the lot treated, homogenize the moisture content before increasing the temperature, and if one could compact the wood to compensate for the inevitable portion of deterioration of the mechanical properties.

In the high-temperature treatment systems that are generally used, only the temperature is controlled. The pressure must be slightly above atmospheric pressure to prevent intrusion of oxygen in case of imperfection of the safety systems, and no pressure can be applied on the wood in the glass phase because of the need to use a battening.

These racks or strips, which would seem to be a detail, are in fact an essential constraint resulting in a significant limitation of the effectiveness of the systems that are generally used.

The purpose of the present invention is to overcome the above-described drawbacks.

A particularly desirable advantage of the invention is the possibility of increasing the range of wood types that can be subjected to heat treatments, where this range concerns the variety of species as well as the shape and dimensions of the wood pieces and their condition; namely, wood pieces that may or may not have received prior treatment with various products.

The purpose of the invention is achieved by a treatment method at moderate or high temperature applied to solid or reconstituted wood, according to which each of the wood pieces of a lot to be treated is arranged in contact with the thermoregulated conductive press whose temperature can be controlled with precision in terms of duration and intensity, and raised to or maintained at the desired temperature by any control and thermal control means appropriate for the treatment and the quantity of wood to be treated, making it possible, by conduction, to heat the wood, maintain its temperature, and cool it.

It is preferred for each of the pieces of a lot to be treated to be arranged between two thermoregulated plates or molds placed in direct contact with the wood and making it possible, by conduction, to heat the wood, maintain its temperature and cool it. The temperature of said plates or molds themselves is controlled precisely in terms of duration and intensity, and it is increased or maintained at the desired temperature by any control and thermal control means appropriate for the treatment and the quantity of wood to be treated.

In addition, the method can have at least one of the following characteristics, considered separately or in any technically possible combination:
one uses electromagnetic radiation, particularly high frequency or hyper-frequency radiation, to increase the temperature very rapidly in the wood piece and homogeneously between the core and the edge, which is particularly advantageous for thick pieces; such radiation can be emitted by any appropriate source, for example, by metal plates or molds of the thermoregulated press, where these plates or molds are then used as emitting antennas arranged parallel to one another;
during the treatment, a force is applied to the plates or molds that distributes the force in the form of a uniform pressure on the wood to be treated;
the temperature of the plates or molds is regulated to reach a maximum treatment temperature which is located, depending on the treatment, in a temperature range of 100° C. to 280° C.;
the temperature of the plates or molds is controlled during the treatment, with a maximum temperature difference between any two points of the treatment plates in contact with the wood of less than 10° C.;
the temperature of the plates or molds is controlled during the treatment, with a maximum temperature difference between any two points of the treatment plates in contact with the wood of less than 0.5° C., when the temperature is greater than 100° C.;
the temperature of the plates or molds is lowered to cool the wood for a latency time of less than 10 min to lower the temperature of the plates by 2° C. from a stabilized temperature above 100° C., if the wood has not undergone exothermic transformations;
one uses metal plates or molds as emitting antenna arranged parallel to one another to emit electromagnetic radiation, particularly high-frequency or hyper-frequency radiation, to increase the temperature in the wood piece very rapidly and homogeneously between the core and the edge, which is particularly advantageous for thick pieces.
one uses a heat source which is configured for a control of the temperature of the plates or molds during the treatment that makes it possible, if the temperature is above 150° C., to lower the temperature of the plates or molds by 15° C. within less than 1 min at any point where the plates are in contact with the wood to be treated, when the wood is not in an exothermic phase;
one controls the temperature of the plates or molds during the treatment of the wood in such a way that the temperature of the plates is maintained, even if heat is contributed originating from the treated wood, as it undergoes an exothermic transformation, with a precision of less than 0.5° C., at a high temperature which is fixed in advance between 150° C. and 280° C., depending on the species treated and the treatment conditions, and corresponding to an exothermic phase of the treatment;
one applies an adjustable force to the plates or molds;
one encloses the plates or molds and the wood to be treated which has been arranged between the plates during the heat treatment in an enclosure equipped with a system that allows control in terms of time and intensity of the vacuum and pressure, with recording of the pressure cycle;
one places at least two sets of plates or molds in the same enclosure, one puts the lots of wood to be treated in place between the plates or molds, and one treats each lot of wood individually according to special criteria that are adapted to this lot and independent of the criteria for another lot located in the same enclosure;
one records, optionally, the pressure cycle of the enclosure and the temperature cycle of the thermoregulated plates or molds, and the temperature cycle of the wood pieces—both at the edge of the piece and in the core of the piece, where the temperature of all the wood pieces is measured, or a sampling is used which is sufficiently well distributed to be statistically representative of the treated lot—is carried out also with a recording of the compression cycle applied, and of the total weight as well as the force applied, to be able to determine the weight change of the wood during the treatment;
when one applies the treatment method to wood that has been impregnated previously with now undesirable products, then, to decontaminate the wood, one evacuates these products by vacuum pumping, the temperature which makes the product to be evacuated liquid and fluid, or gaseous, and which generates an excess pressure in the wood, being optionally increased by the compression beyond the glass transition temperature which reinforces this excess pressure by decreasing the pore space; at a much higher temperature than the melting temperature of the products, one recovers all said products that were introduced previously into the wood, using, as a result of the temperature reached in the method, a fluidity which is sufficient to convey liquids, fluids and gases to tanks that are assigned particularly for this use, in a circuit made of an appropriate material, where the circuit is maintained sufficiently hot to preserve the fluidity of the products and to ensure their loss-free conveyance to the tanks in question, and where the circuit is equipped with the required circulation means, and the tanks are equipped with means for condensing the gases.

The purpose of the invention is also achieved with an installation to carry out the above-defined heat treatment method, i.e., with an installation for treating solid wood or reconstituted wood by applying a moderate or high heat, which comprises at least one thermoregulated conductive press placed in direct contact with the wood to be treated, where the temperature of the press can be controlled with precision in terms of time and intensity, and raised or maintained at the desired temperature by any control and thermal control means appropriate for the treatment and the quantity of wood to be treated, where the press makes it possible, by conduction, to heat the wood, to maintain its temperature and cool it, and where the installation comprises in addition means that are intended to record the temperature curve of the thermoregulated press.

According to a preferred embodiment of the invention, the installation comprises a press with at least two thermoregulated plates making it possible, by conduction, to heat the wood that has been placed between the plates, where the temperature of said plates themselves is controlled with precision in terms of time and intensity, and raised or maintained at the desired temperature by a control and thermal control means appropriate for the treatment and the quantity of wood to be treated, and a means intended for recording the temperature curve.

The installation can, in addition, have at least one of the following characteristics, considered separately or in any technically possible combination:
the installation comprises a means intended to record the temperature curve;
the installation comprises a means intended to record the temperature curve of the thermoregulated presses (plates or molds) as well as of the wood pieces whose temperature is measured by heat sensors that are inserted into the end of each piece on the external edge, on one hand, and in the core, on the other hand. Instead of measuring each wood piece, one can measure and record a sufficient number of wood pieces, using a statistically representative distribution, to have a statistically representative sample of the treated lot.
the installation comprises means intended to record the weight of the entire treated lot; it may be sufficient, for example, to have all the plates be supported on a plate at the low end of the enclosure, where said low plate itself rests on the floor through the intermediary of a scale that makes it possible to measure the weight lost by the treated lot from the difference compared to the compression force applied to the entire lot to be treated, which itself is known, measured and recorded.
the installation comprises independent exchangers so that several lots of plates or molds located in the same enclosure can undergo, at the same time and in the same enclosure, different temperature cycles;
the installation comprises means that allow the plates to exert, during the heat treatment, homogeneous pressure on each wood piece in question, taking into account the appropriate arrangement of the plates and of the wood to be treated, which is placed between the plates, where the pieces are installed in stacks with wood pieces of constant thickness between each pair of successive plates;
the installation comprises means allowing each plate, except the one at the very bottom of a set of several plates or molds, to add a mechanical stress applied to the top plate or mold, resulting, throughout the entire stack, in a managed and controlled excess pressure which is added to the pressure exerted by a plate or mold on the wood pieces on which it rests, because of its own weight and the weight of the plates and of the wood located higher in the stack;
the installation comprises a device for the management and control of the pressure of each plate or mold on the wood pieces in contact with the plate or mold in question, without consideration for the weight of the plates or molds or other elements;
the plates or molds intended to receive, for heat treatment, wood pieces, are arranged horizontally with at least one jack on the plate located at the top of the set of plates or molds, to exert the same pressure on all the wood pieces treated;
the plates or molds intended to receive for heat treatment wood pieces, are arranged vertically with the jacks on the plates or molds located at the end to exert the same pressure on all the wood pieces treated;
the installation comprises means for the recovery of juices or fragrances extracted from the wood during the treatment, with one or more tanks for differentiated storage in a special tank for storing the fragrances and juices originating from the wood in a differentiated manner in a special and approved tank. Depending on the species, on the one hand, and the temperatures, on the other hand, the juices and the gases originating from the wood have a specific aroma composition, and these different compositions can made commercially useable by an ultrafiltration or reverse osmosis system allowing the concentration of the compounds that are usable in pharmacy, perfumery, cosmetology, or to extract fragrances and flavors for the food industry. To raise the value of these products, it is possible, according to the invention, to provide a large number of tanks and a set of valves to direct and distribute the juices and the gases as a function of the species and the extraction temperature. The gas can be collected by condensation of the liquid juices in different tanks. The selectivity is a valorization factor for the extracted products. Moreover, a more or less advanced filtration allows the purification of the water, for example, and such an installation is used at the same time as a purification station.
the installation comprises a heat exchanger and a heat-conducting fluid that circulates in the plates at a determined flow rate through a circuit to exchangers adapted to the maximum treatment temperatures, which are between 100° C. and 280° C., depending on whether the treatment is complete or limited to only some of its potential possibilities, where the temperature of the plates or molds can be managed during the treatment, taking into account the thermal inertias, and in spite of the perturbations connected with the heat exchanges and with the treated masses of wood, with a maximum temperature difference between any two points of the treatment plates in contact with the wood of less than 10° C.;
the installation comprises a means intended to cool the wood in a latency period of less than 10 min to lower the temperature of the plates or molds by 2° C. from a stabilized temperature above 100° C. when the wood has not undergone exothermic transformations;
the installation comprises a means intended to decontaminate a wood that was previously impregnated with now undesirable chemical products; to this effect, the installation comprises, in addition to the means for heating the product to make it liquid and fluid or gaseous, and in addition a means to evacuate it by creating an excess pressure by the heat and the crushing of the pore space above the glass temperature, tanks that are particularly adapted to the recovery of liquid or gaseous products, and a means for condensing the gaseous products to be condensed, comprising, in addition pumps to generate a vacuum in the enclosure, a circuit to convey the products to these tanks, a means to cause the product to circulate in the circuit, where said circuit is made of an appropriate material and maintained sufficiently hot to preserve the fluidity of the products and to ensure their loss-free conveyance to the tanks in question.

The purpose of the invention, finally, is achieved with solid or reconstituted wood that has been subjected to a treatment according to the above-described method.

In the method according to the invention, it is precisely possible to go beyond the limits of the methods currently used by intervening in two factors:
It has been agreed that the use of a thermoregulated press makes it possible to confer to the wood a precise temperature for a precise duration. It is possible to lower the temperature in the entire piece abruptly and to main it constant at a very precise temperature, even in a situation of exothermicity, and it is possible to considerably reduce the two thermal inertias pertaining to the rise in temperature, because conduction is more effective than convection, and compression above the glass transition temperature decreases the porosity and increases the contact surfaces between the wood cells, making it possible to increase the conductivity.
It is agreed that the use of the thermoregulated press in an enclosure in a vacuum makes it possible to manage with precision four parameters that also the influence the thermolysis, instead of a single one:
=the precise management of the temperature, and the management of the summary of the times of exposure of the wood to a given precise temperature
=the management of the compression of the wood (which is the result of a force supplied to the press and transferred to the wood in the form of uniform pressure),
=the management of the vacuum and the pressurization of the enclosure,
=the management of the chemical environment through the confined gases (gases originating from the wood because of the thermolysis and remaining in the enclosure starting from the time chosen to stop or decrease pumping applied to the enclosure).

Indeed, because of the low thermal inertia, the method allows greater precision: if applicable, it makes it possible optionally to increase the heat, with temperature determination to the nearest degree for an extremely precise duration, because the temperature is lowered again without delay. The entire curve, with respect to time, of the triplet (temperature, compression, pressure) characterizes the method and the Thermoduralyse®. The thermolysis kinetics are changed upward by the pressure, which may be greater than or less than atmospheric pressure, and by the concentration of gases originating from the ongoing thermolysis that serve as catalysts and that participate in the thermolysis, especially the free radicals originating from the cleaving of the hemicellulose, and where this concentration as well as the composition of the gases depends on the time when one lowers the pumping of the enclosure and on the volume of the enclosure and the history of the more or less selective pumping of a given part of the gases. Thus, it is the physico-chemical environment that can be managed and controlled by the three curves. By varying the curves of the three parameters, the heat treatment is consequently more precise and more sensitive. The compression itself intervenes in that it decreases the thermal inertia in the wood, while also changing the pressure in the pore volume of the wood and the geometry.

In addition, while the thermoregulated press is perfectly effective not only for heating, but also for maintaining the temperature and for cooling, it is possible, according to the invention, to add another heat source by radiation, which is not a substitute for the radiation to maintain a temperature in spite of the exothermicity or to cool the wood abruptly, but which instead is added to accelerate the temperature increase.

Indeed, it is known that pressure is an important factor in accelerating the reaction and increasing its completion. A probable interpretation relates to the fact that the frequency of cleaving must not be affected, but to the fact that the probability of encountering a free radical increases and the number of bridges increases more rapidly, proportionally to the destruction of fibers.

Finally, the parameter of compression intervenes directly, and independently of thermolysis, due to the fact that compaction increases the number of fibers per unit of volume and increases the mechanical performance proportionally. Thus, notwithstanding the mechanical degradations due to thermolysis, these losses can be compensated by the compression, and one can even have, as a result of all the actions together, an improvement of performance.

Taking these differences into account, the method according to the invention makes it possible to define the new concept of “Thermoduralysation®” whose purpose is to obtain, by the controlled thermolysis of the wood and thanks to the optimal management of the different parameters that the method according to the invention makes it possible to control, a more durable wood that is mechanically more resistant and more homogeneous than the woods obtained according to the current state of the art.

The result of the Thermoduralysation® of the wood is a homogeneous treatment whose effect is to reduce its hygroscopy, improve its dimensional stability, increase its resistance to degradation agents, and increase the hardness of the surface, while not decreasing substantially, or increasing by compaction, its physicochemical properties, and changing the color of the wood which takes on a light brown color in the mass, as a function of the species and of the applied treatment parameters, which color will be permanent in the absence of exposure to the sun. Surprisingly, but logically, the most hydrophilic species, (because richest in hemicelluloses) become the most hydrophobic due to the fact of their thermocondensation on the ligno-cellulose cell structure.

The wood preserves its structure because the cellulose that has not been altered preserves its crystallinity and the reinforcement of the material thus remains unchanged. The Thermoduralysation® changes the behavior of the wood, which behaved like clay with respect to water, and will behave like sand. There is a slight increase in the porosity, the wood becomes hydrophobic, and there is an improvement of the wettability with respect to oils, paints, monomers, glues and different products due to a modification of the surface tension.

The Thermoduralysation® of wood (whether it is in the form of a solid wood piece or a piece of ligno-cellulose material, with or without binder) can be defined as a managed thermolysis of the wood that leads to crosslinking (covalent bonds, chemical bridges) between the macroscopic chains of the constituents of the wood according to the criteria of the present invention, and that makes it possible to optimize the improvements in term of imputrescibility, dimensional stability and hydrophobicity of the wood, while at the same time maximizing the homogeneity of the treatment and minimizing the losses of mechanical performances, and particularly losses pertaining to behavior under flexion.

The Thermoduralysation® is carried out in the context of the treatment method according to the invention, with wood being placed in contact with a thermoregulated press; i.e., a press that has plates or molds configured to be heated or cooled according to a predetermined program, but also according to the instantaneous needs as the method is carried out.

For certain applications, it will be preferable to place the thermoregulated press in an enclosure that can be pressurized under a slight vacuum up to a predetermined temperature beyond which the enclosure is closed sufficiently hermetically to confine the gases in the wood originating from the thermolysis reactions.

In an enclosure, the Thermoduralysation® takes place essentially as follows: the temperature is increased according to a precise combination of temperature, wood compression and enclosure compression curves, and it is maintained for a certain duration at the maximum temperature of the treatment, which is between 200° C. and 280° C., preferably between 230° C. and 240° C. The choice of the pair of parameters (maximum temperature, a duration of exposure to said maximum temperature) depends on the species of the wood, the thickness of the wood to be treated, the compression of the wood due to the effect of the thermoregulated press, the confinement pressure, and finally, the pressure increase curve, as well as the intended use for the wood, although it is not necessary, according to the invention, to proceed to a temperature plateau at the glass transition temperature.

Thus, the Thermoduralysation® according to the present invention does not content itself with being a novel way to control only the temperature of the wood in a given chemical environment; on the contrary, it is a novel means to control simultaneously several parameters including the temperature, which, incidentally, can itself be managed much more precisely than with the known methods. In addition, the goal of achieving high performance leads to moving outside the ranges defined previously by the two crosslinking versions that were reviewed above.

The method of the invention and its embodiments are two essential characteristics that make it possible to overcome the drawbacks of the generally used methods and to obtain the expected result. The first of these two characteristics is that the wood to be subjected to thermoduralysis is contacted, during the treatment, with a thermoregulated press. This press, which can also be called a thermoregulated conductive press, because it comprises at least one heat conducting plate or any other solid and heat conducting mold, and at least one other plate or mold which transmits heat in direct contact with wood. The plates or molds, which, incidentally, can be solid or perforated, are heated to a temperature which can be increased, maintained and lowered according to a temperature curve, which is preferably predetermined, and which is such that a heat flow is transmitted to the wood by conduction, and secondarily, significantly or not significantly, by radiation, but not by convection, since there is no separation between the wood and the plates, and no mutual displacement. The optional addition of heat by convection, in the case of perforated plates, remains marginal in comparison to the transfer by conduction.

During the thermoregulated treatment, the plates or molds, according to the invention, can be subjected to a force which is distributed over the wood in contact with which they are, in the form of a homogeneous pressure.

The second characteristic of the wood to be subjected to thermoduralysis is that this wood is raised to a Thermoduralisation® temperature as a function of the species, and it is preferably between 230° C. and 240° C., and that the wood is maintained at this Thermoduralisation® temperature for a duration which is a function of the species and of the thickness of the wood, as well as of the mechanical pressure applied by the press. However, this duration, in general, does not exceed 30 min per centimeter of thickness.

Usually, the wood is in the form of planar boards or plates that are placed on a thermoregulated plate and covered with another plate. The thermoregulated presses used in the context of the present invention, according to a chosen embodiment, have only thermoregulated plates or molds, or, in addition to thermoregulated plates, plates or molds that are not thermoregulated and intercalated between two wood levels.

According to a variant of the invention, the press may comprise two rigid plates or molds that are kept at a distance from each other by any mechanical means that withstand the forces, such as, for example, by two perpendicular pillars, or by a single perpendicular pillar making of the assembly of the two plates or forms, or of the two perpendicular pillars, a hollow tube, or, respectively, an I-shaped profile (including an IPN standard profile), with the single perpendicular pillar in the center.

In addition, the press can also be used itself to emit hyper-frequency radiation, or it can be connected to an electromagnetic field generator to heat the wood in the mass:
for the purpose of accelerating the temperature rise process in spite of the thickness of the wood (especially to treat flitches). Obviously, electromagnetic radiation emitted by a metal body can increase the temperature but not maintain it in spite of the exothermicity, and even less cause it to decrease. This is the reason why this is an important means but only a complementary means for the conduction means of the thermoregulated press; and
for the purpose of approaching the sensitive phase with a very low gradient, since the heat is not transmitted uniformly from the edge to the center, but produced by reaction to the radiation in the mass.

Electromagnetic waves are already used to heat a material, and the method is used for drying wood (which is easier due to the fact that the wood to be dried is wet, and water is particularly easy to heat by electromagnetic waves).

A description has already been provided in the document FR-A-2 751 579 showing that one can benefit from a temperature that is higher than the glass transition temperature to exert a force on a part of the wood piece to modify the density or the shape of this part. This is the classic use of the glass transition with polymers to shape them, where the shape is acquired permanently with rigidity when one lowers the temperature of the piece, and this property has been used since ancestral times in the case of wood by the cask makers who use it to bend the boards of casks.

In the document FR-A-2 604 942, the possibility is also described of using a hot press to transfer heat to the material between the heated matrixes of the press during the pressing.

The problem to be solved at the time of the invention was not to find a means to increase the temperature, because it has been known in physics for a long time that these means are convection, conduction and radiation. Rather, the purpose was to obtain increased precision with the pair of parameters (temperature, duration of exposure), and to achieve this one must be able to:
decrease the time required to achieve a uniform temperature of the piece at the desired maximum temperature during the temperature increase
maintain the temperature at a precise temperature even in case of exothermicity
be able to lower the temperature very rapidly without delay throughout the entire piece when the duration of exposure has elapsed
decrease the factors of heterogeneity of the temperature. However, temperature is a conservative value which integrates all the differences connected with the flows, the differences in moisture content, and heat flow during the entire treatment.

The method according to the invention uses a novel combination of the classic principles of physics that have been used separately.

To decrease the gradient, one needs an adequate temperature rise curve and a means for heating with low inertia: conduction and the internal conductivity which is increased by compressing at a temperature above the glass temperature to decrease the pore space make this possible, where a complementary heating by hyper-frequency radiation or any other electromagnetic field increases the temperature in the mass (and breaks the ends of molecules which form free radicals) makes it possible to adequately meet the objective of a rapid temperature increase while minimizing the temperature grade inside the wood piece.

To maintain the temperature as well as possible, a system is needed which is equipped with means for cooling by conduction, and the wood must be compressed wood.

The compression of the wood requires an additional cost, because the size at entry must be greater than the size at exit, but this makes it possible to improve the quality of the wood without changing its appearance.

In addition, the fact of compressing the wood, the fact of confining it, and the fact of having a low pressure or a high pressure in the confinement enclosure, have an important influence on the reaction kinetics of the Thermoduralisation®, and the method consists in varying the four parameters:
temperature curve of the plates
compression curve
pressure curve in the enclosure, and
radiation field

The invention resides simultaneously in the means used and in the temperature curves which are different from those that are known (absence of a glass transition temperature plateau and maximum temperature below 240° C.), and in the fact that this embodiment uses more cost effective woods (polluted woods, woods of small size, etc.), which was not possible in the embodiments known in the state of the art; moreover, this embodiment achieves large savings (energy+nitrogen) and also time savings (divided by 2), and it makes it possible to save on structures (several different lots with different treatments in the same enclosure) and savings due to the fact that this storage is undifferentiated thanks to the treatment with flitches; in addition, through the cooling energy, it allows the recovery of a large part of the energy required for the treatment, which energy is recoverable, according to the invention, in form that is usable to carry out another treatment, which means that in practice the energy saving is greater than 50%.

Heating presses in a vacuum enclosure without means to cool to temperatures below 100° C. have already been used to dry wood.

Such presses are not usable here, because heat-conducting liquids, exchangers, and plates constructed to resist temperatures above 200° C. are needed.

In addition, thermal inertia dimensions are needed which are adapted to the use, and an exchange system is needed that presents at least one heat source and cold source, and a set of valves and automated devices to regulate the rising temperature, maintain it in spite of exothermicity, and cooling, and not only to heat the plates.

In addition, if one wants to connect a hyper-frequency wave field generator, more adaptation is necessary.

The existing techniques allow the construction of such a system, which is the combination of elements whose technology is known to the different bodies of professionals of industrial fabrication.

The thermoregulated press itself can be thermoregulated by any useful and effective means. In particular, it can be a hollow body, for example, two planar plates that are separated from each other by mechanical means, and immersed in a thermo-regulated bath, so that the liquid between the plates heats the conducting plates to the temperature of the bath, or it can be a primary circuit with a circulation of heat-conducting liquid which heats the plates to a regulated temperature close to the temperature of the heat-conducting liquid, with a difference which is managed by calculating the thermal inertia and the conductivity of the system.

Finally, according to a variant of the invention, the press can consist of two rigid plates that are kept at a separation from each other by any mechanical means that withstands the forces, such as, for example, two perpendicular pillars, or a single perpendicular pillar, making of the assembly of the two plates and of the two perpendicular pillars a hollow body, or, respectively, an IPN shape, with the single perpendicular pillar in the center. According to this variant, each of the two constitutive plates of the press can be thermoregulated individually. However, another possibility is to have liquid or gaseous convection between the two plates that are integrally connected to the conductive press. In this case, the convection heats the conducting plates, and these plates in turn heat the wood in contact with them. In the furnace enclosure of the prior art such presses consisting of two conducting means could be used, where the conducting plates were separated by a mechanical means that transfers the charges from one plate to the other, allowing a gaseous flow to pass between the plates. In this case, the plates play a role of mechanical distribution plate spreading the applied force, and a heat conducting role: the plates are heated by convection, and they heat the wood by conduction and radiation.

In a variant, where the plates or the molds are perforated, they are not completely impermeable. For example, they can be grids whose holes are sufficiently small at the surface to leave no significant traces in depth when a force is applied to the wood, and to prevent the plate from damaging the wood piece. While the effect of the holes is negligible, this does not change the usefulness of the system as it provides an additional advantage.

In the preferred case, where the perforated plates are thermoregulated with a primary circuit, where the entire setup is in a vacuum enclosure, and where the holes have no visible influence on the homogeneity of the pressure and conduction, allowing the passage of a liquid or gaseous flow which could be absorbed by the wood pieces in the cooling phase, regardless of whether a phytosanitary treatment, a paraffin, binders, etc., are involved. Perforated molds can be used to cause the binder to penetrate into an agglomerated product.

The wood treatment method according to the invention comprises a succession of treatment phases each ensuring the control of three parameters, namely the heat added to the wood, the pressure of the confinement enclosure, and the mechanical pressure exerted on the wood.

The present invention thus relates to a wood treatment method which consists, in addition to the prior step of drying the wood, of at least one of the steps of the complete treatment comprising the harvesting of the fragrances of the wood, the decontamination of the wood if it was treated previously with chemical products, the compaction of the wood, the straightening of the wood if it is buckled or insufficiently flat, the different stages of the modification of the ligneous material due to the action of heat, particularly the calorimetric modifications, and ultimately the crosslinking of the lignins and, finally, the absorption of different additives as a result of the effect of the low pressure in the pore space of the wood during the cooling phase.

In addition, in contrast to classic convention, and because of, according to the invention, the low thermal inertia of heat conduction, one can manage the temperature of the edge of the wood with a relatively shorter delay compared to the temperature of the plates and, on the other hand, with a better thermal conductivity K. Indeed, according to the invention, the thermal conductivity K is improved because the wood has been crushed onto itself due to the effect of the homogeneous pressure exerted on the wood pieces which becomes increasingly malleable when it exceeds its glass transition temperature, between 170 and 180° C. depending on the species. Thus, the temperature difference between the edge of the wood and the core of the wood is very largely reduced and this temperature occurs very quickly after the increasing or the lowering of the “nominal” temperature conferred by the plates. Thus, according to the invention, it is possible to manage with precision the temperature of the wood between 130° C. and 140° C., even in the absence of any temperature plateau.

However, if one so desires for the purpose of improving the quality by increasingly refining the homogeneity, one can also use several temperature plateaus at one or more of the intermediate temperatures to arrive at the delicate phases with a low thermal gradient.

Such a temperature plateau could be located, for example, between 190° C. and 200° C. to reduce the temperature gradient to a minimum very close to the final treatment temperature which is between 230° C. and 240° C. depending on the species, but, preferably, not to a higher temperature so that the homogenization does not perturb the final results of the treatment. If so desired, one can also use an intermediate temperature plateau, for example, between 150° C. and 160° C., to approach the glass transition, and at the same time, the high-temperature treatment with a wood that has a uniform temperature.

The duration of such temperature plateaus can be managed by representative heat sensors as a function of a maximum temperature difference allowed at the end of the plateau between the edge and the core of the wood, where this maximum difference can be zero, or 2° C., or 5° C., or any other difference deemed appropriate to not lose too much time while at the same time guaranteeing the wanted homogeneity for the last phases of the treatment.

Moreover, on the one hand, the treatment inside the wood is ideally between 130 and 140° C. at atmospheric pressure and without compression, but it can optionally be at a higher temperature due to the possible low pressure in the enclosure, or the possibility of lowering the temperature very rapidly within a very short time.

Moreover, the temperature of the plates can be much greater than that of the wood, to allow a large heat flow by conduction between the plate and the wood to shorten the delay due to the rise in temperature inside the wood, where this higher temperature of the plate can be followed by an abrupt cooling of the plate to heat it to and maintain it at the maximum treatment temperature for a chosen duration of exposure. Such a practice can present the drawback of burning the outer surface of the wood, where the burn can disappear following planning of the four faces, as is usually done after such a treatment.

For these two reasons, and in spite of the previous analysis which shows that the ideal treatment temperature inside the wood for durations of exposure of 5′ is normally between 230 and 240° C., the temperature of the conducting plates can be increased advantageously to clearly higher temperatures, up to 280° C. or even 300° C.

If one considers, according to the invention, what happens when pressure is generated in the wood by mechanical stressing of the wood, which is compressed between two heating plates exerting a pressure on the edges, and, particularly, when the wood has reached its glass phase (starting at a temperature of approximately 150° C.), one observes that the wood “crushes onto itself” by increasing the “crushed” contact surface area of the solid parts one on top of the other, and by considerably reducing the pore space.

However, conductivity K in question here is indeed very obviously an equivalent conductivity, which is the resultant of the conductions taking place by different paths between cells that are full of water and the porosity volume which is full of gas.

Since, at approximately 150° C., the pore space is completely empty of liquid water (particularly if the temperature increases), one reaches the glass phase which makes the wood plastic. The crushing of the wood is then possible because the glass transition and the insulation of the wood are at a maximum because the porosity volume is empty of water. Since it is known that the conductivity of water and thus of the cells of the wood with their constitutive water is on the order of 0.6 W/MK, while that of a gas, air or steam is on the order of 0.03, or 20 times less, the possibility appears of multiplying the factor K by a non-negligible factor by crushing the porosity, and, in fact, it is possible to use a reasonable amount of crushing to multiply K by a factor of 1.5-2 (or more, incidentally, depending on the crushing) by the double effect increasing the contacts between the cells of wood with constitutive water and decreasing the gas-filled porosity volume; it is also known that, geometrically, the thickness to be traveled through decreases with the crushing between the surface and the core of the wood.

Thus, one has the possibility of regulating these three factors, which required the use of a glass phase plateau as well as the management of the end of the crosslinking:
the wood being mechanically stressed does not risk expanding and, thanks to the glass transition, it will be kept crushed and compacted, without cracks
the factor K is increased, and the transmission inside the wood is accelerated, and
the transfer by conduction occurs very rapidly, and there is no longer inertia which had required several hours of re-equilibration of the temperature inside a wood piece, even if it was thin, at 150° C.

Consequently, the temperature plateau in the glass phase of the method described in the document FR-2 751 579 is no longer needed. Similarly, the risk of having a curve which exceeds the crosslinking temperature, or the risk of not treating down to the core, or of the treatment not being homogeneous, disappears also for three reasons:
the factor K has been increased, and thus the diffusion in the wood becomes good, allowing heating everywhere up to the chosen temperature without exceeding it, and easy and rapid cooling if desired
the heat is transmitted to the wood without inertia, and without any uncertainties due to the conduction with plates, which prevents differences between the beginning and the end of the stack, and the effect of the quantity of water in the gas
the plates have a known temperature at all points, while, in contrast, the speed and the temperature of a heat-conducting convection fluid cannot be controlled without great difficulties.

A fourth reason is the possible use of an electromagnetic field to increase the temperature rapidly and without temperature gradient inside the wood, even with a thick wood piece.

According to the invention, the heat is transmitted to the wood by conduction, as the wood is in contact with a homogeneous heating plate which is at a control temperature and presents sufficient inertia. The heat treatment can also be improved, notably for the treatment of thick wood pieces, by applying a heating plate to the two faces of the wood, and by generating a pressure on the wood through the intermediary of a force applied to the plate. An additional improvement can be obtained by using a vacuum enclosure. The pressure plays a triple role:
The mechanical pressure increases the pressure inside the wood by decreasing the pore volume, which is reflected initially in an increase of the pressure for a given gas quantity, until the evacuation of the excess gas inside this porosity no longer succeeds in re-equilibrating the pressure between the porosity of the wood and the exterior. The internal pressure of the porosity of the wood thus becomes greater than the external pressure, which allows an easier evacuation of the liquid or gaseous effluents, preventing external gas from re-entering and replacing the empty spaces left by the evacuation of the effluents, and it allows the internal forces of the wood to oppose each other.
The absence of air or gas sheets inside the wood, which make the dry wood be an insulating material, allows the compressed wood to be a good heat conductor, a fundamental factor in terms of profitability and precision of the temperature equilibrium.
The mechanical pressure prevents deformations and, on the contrary, serves to benefit from the glass phase to straighten the wood.
In contrast, if desired, a special pressure can exert non-homogeneous forces on the wood, to give it a special shape; a solid wood piece can be curved or bent, and agglomerated wood in a mold can receive the imprint of the shape of the mold.

The major problem of the treatment was the weakening of the mechanical performances of the wood; this weakening can be reduced to a minimum and compensated, or even better these properties can be improved by compacting the wood:
it has been seen that one can manage the temperature best at the time of the crosslinking, and one can thus choose to use compromise performances, for example, by remaining for 5 min at 240° C.;
thanks to the vacuum enclosure, no oxygen is present, and the only gases that are present are the free radicals which one has kept by stopping to pump at the start of the chemical reactions;
the compaction in the glass phase and the crosslinking of the compacted wood are two irreversible events, if one lowers the temperature again. The compaction compensates largely, if desired, for the losses of mechanical properties allowing, on the contrary, the treatment to induce an improvement of these mechanical properties (with, however, a greater consumption of material, if one needs, for example, a 35-mm board to make a 27-mm board after compaction).

Cooling phase after crosslinking: the vacuum enclosure has the characteristic of a super autoclave, because one can introduce a product into the enclosure and benefit from the cooling vacuum. It is not necessary to sprinkle water to cool, and one can cool rapidly; in addition, if one so desires, one can release some of the compression for an expansion of the crushed wood.

These objectives are obtained according to the invention by the fact that a vacuum drying process which minimizes the waiting time using the free water as a heat vector into the core, which is particularly important for a thick wood, and using the mechanical pressure exerted on the wood and conduction to overcome the thermal inertia, all within a reasonable time period; this is a result that the current state of the art cannot achieve in a competitive time period.

The planks of any width cause no problem with the technology that uses plates, because no stacks need to be produced and, on the other hand and especially, there is no risk of buckling during drying, since mechanical stress is applied and, on the contrary, the woods are planed again and remain flat subsequently.

This same operation can be carried out by delignifying contaminated railroad ties, but there is no step of prior drying to remove free water because there is none.

Other aspects concerning the method and the installation according to the invention and their advantages are evoked below in a free order that is unrelated to the importance that they may have.

Vacuum enclosures with stacking and heat conduction plates exist for vacuum drying with control of the temperature, the enclosure pressure, the stack weight, and with recording of heat sensors in the core and on the surface of the wood.

However, the plates used in the invention are different (new material and new shape) to adapt to the temperatures and pressure of use; and the exchangers also have to be adapted to temperatures ranging up to at least 240° C., or 280° C., and even 300° C., when the vacuum drying is carried out between 30° C. and 80-95° C. as maximum.

The mechanical stresses are different to be able to exert a strong pressure on the wood, and it may be necessary to create a model with vertical pillars if one wishes to have not only a minimum pressure but also a uniform pressure.

A heat-conducting fluid is needed that is capable of having a rheology allowing a good circulation and good heat exchanges in the temperature range from 20° C. to 250° C. or even to 300° C.

Outside of the enclosure of the furnace, a refrigeration central unit and a system of exchangers are needed for the heating, temperature maintenance, or cooling of the primary circuit coming from the plates.

It is preferred to connect a furnace in the heating phase and a furnace in the cooling phase, but this is a matter related to industrial heating engineering by means of fluid exchangers without vapor phase.

It is necessary to have a circulation of the flows, and thermal inertia.

A set of tanks are required for the recovery of the different juices and for the incorporation of treatment products in the cooling phase of the product: all these elements and precautions are known to manufacturers of autoclave furnaces.

According to the invention, the vacuum enclosure makes it possible to recover everything that comes out of the wood.

In addition, the technique according to the invention allows the crushing of wood in the glass phase to decrease the pore space and create a very strong excess pressure inside the wood, which, when used in addition to the vacuum in the enclosure produces the optimal characteristics to evacuate the chemical products that were previously injected.

These chemical products (such creosote or the CCA treatments), which have become undesirable wood contaminants, were introduced into the wood in the past intentionally to make the wood more resistant to cryptogamic attacks or other attacks. However, these products are introduced into the wood at temperatures on the order of 90° C. or lower, using autoclave methods in which one uses the low pressure in the wood when it is cooled after having first been heated, with chemical products introduced in a heated and pressurized enclosure. The method according to the invention makes it possible to heat the wood at temperatures that are higher than those used in the previous introduction of the product. It is possible to heat to 190° C., which is a temperature that is above the glass transition temperature of the wood, so that one can crush the wood, and due to the decrease in the pore volume combined with a very high temperature, obtain a very strong excess pressure in the wood with volatile or liquid, but very fluid, products (ideal rheology, ideal excess pressure).

At the same time, a low pressure in the enclosure in which a vacuum was generated simultaneously promotes migration of the products out of the wood, by increasing the pressure difference between the interior and the exterior of the wood, and collecting these products outside of the treatment enclosure and conveying it to a special tank for the recovery of dangerous products.

A temperature plateau at 190° C. with the vacuum enclosure is desirable to allow all the juices to come out of the wood and be collected. Then, one stops applying the vacuum, and one increases the temperature and the exiting volatile products.

According to the invention, the vacuum pumping makes it possible to recover all the products that were previously introduced into the wood, at a much higher temperature than their melting temperature. This allows the obtention of a sufficient fluid of the liquid juices, and a volatilization of a part of the products. The juices and the volatilized products can thus be conveyed very easily to the tanks that have been assigned particularly for this purpose, in a circuit made of an appropriate material, for example, stainless steel. The circuit is kept at a sufficiently high temperature to preserve the fluidity of the products and ensure their loss-free conveyance to the tanks in question. In addition, the tanks are provided with means for condensing the gases and the volatile products in the tank.

During the heat treatment cycle, the pressure of the enclosure can be varied with the help of a control means.

The control example below is an example of the embodiment of the treatment with a contaminated wood:

Low pressure from the start of the vacuum treatment enclosure on during the drying phase, and then, during the temperature increase and the glass phase, to recover the juices (species, decontamination, etc.) up to 190° C. An optional heat treatment can be carried out, if necessary at 190° C., until all the contaminating juices have been extracted.

Stopping of the vacuum (at the end of the optional plateau) starting at 190° C., and slight excess pressure to preserve the free radicals that originated from hemicelluloses, in particular. It is important not to continue in a vacuum during the hemicellulose and lignin cleaving phase so as not to evacuate the extracted volatile products that are useful for the crosslinking. Once the unoccupied volume between the enclosure and the stacks of wood is not large, the products originating from the wood are sufficient to cause the pressure to increase as the temperature increases.

In the absence of chemical products to be recovered, or if none are left at these high pressures above 150° C., it can be preferable to stop the vacuum at a temperature below 190° C. to cause the temperature of the enclosure to rise earlier and higher, and to make the volatile free radicals originating from the cleaving of the wood molecules available more easily for the crosslinking reactions.

Atmospheric pressure or pressurization during the cooling, to cause the products to be absorbed in the wood: this is similar to an autoclave, but at a much higher temperature allowing the absorption of products having a higher melting temperature (high-temperature melting paraffins, for example).

The method and the installation according to the invention also allow the treatment of green wood.

It is known that the adhering live nodes may continue to adhere if they are treated in green wood, the sap probably acting as binder. It is useful to have the possibility of drying under a vacuum to avoid the collapse, accelerate the process, obtain evenness of drying, and continue the treatment without break, loss of energy, or loss of time.

It is also possible to cause a controlled collapse to create a new decorative product. By controlling the intentional collapse of oak wood, in particular, one can obtain oak boards that one intentionally exposed to attack by the “second hand store worms,” particularly oak sap wood to create “pre-aged” board, which one then stabilizes in that condition.

Green wood constitutes an ideal quality, because it is a heat conductor allows a time saving, and homogeneity to be achieved, and one obtains adhering nodes with green wood.

Moreover, vacuum drying with a heating place is the most rapid and precise means to carry out the drying during the first phase.

To reduce the consumption of energy, the installation according to the invention can be constructed in such a way that the cooling energy is recovered. Thus, the method of the invention requires no energy except to make up for losses and latent transformation heat during the drying.

In the current state of the art, it is not possible to recover the heat calories of the wood when cooling the wood, because this cooling is carried out by the injection of water which cools the flow by evaporating: one cannot use this heat to heat another charge, because the heat locked in the wood is stored as latent heat of transformation, and the air would have to be dried in a heated pump to recover them, which would cost more than the price of the recovered heat. However, in a cycle, the wood is placed in a furnace at 20° C., and it will be stored at the same temperature. To reduce the cooling time, the wood is taken out at 80° C., but at temperatures above 100° C. it ignites spontaneously in air. Much heat is lost (8% of the treatment price).

On the contrary, according to the invention, the plates constitute a primary circuit exchanger with the wood, and all the heat is recoverable between two treated lots with opposite phases, one wood lot being cooled while the other is heated, with a primary circuit in the plates that exchange by means of exchangers with a secondary circuit. It is possible to use the energy of a lot of hot wood which one has to cool before taking it out into the air at 40° C. to heat another lot of wood located in another cell with a very large energy impact, since the energy to cool wood from 250° C. to 50° C. is, disregarding the losses and internal chemical energies or phase change energies (evaporation), equal to the energy required to raise the temperature of an equivalent mass of wood from 50 to 250° C.).

A liquid at 50° C. can preheat wood to 20° C., and the organization of the storage of heat in balloons and of the exchange, with management of the exchangers and phases, must be optimized by a person skilled in the art.

Another solution, according to the invention, consists in having hollow plates, such as metal tubes, and in immersing the lot in a thermoregulated bath whose liquid reenters into the hollow spaces and heats the plates which transmit by conduction heat to the wood, and which, moreover, also transmit by compression a force that is applied, for example, to the plate located at the end of a stack.

One of the intended goals is to be able to treat much thicker wood than the 27- or 35-mm boards that are usually treated. The object would be to treat woods of all widths over a thickness of 10 cm, and ideally 15 or 20 cm. The advantage is to be able to delignify boards whose width must be within the thickness of the flitch; thus, for boards having a width of 8 cm, a flitch having a width of 8 cm is needed, and most of the classic boards having a width of less than 10 cm, the fact of being able to carry out the treatment up to 10 cm is already of great interest.

If the treatment time for 16 cm is not too long, the 16-cm flitches make it possible to produce very wide boards, which is advantageous for a wood that does not fragment, and it also allows the production of two boards having a classic width of 8 cm.

This means that treated flitches can then be delignified to produce boards of variable width, and above all of any thickness. Thus, the crosslinking of the flitches allows storage with any treatment. In addition, the flitches undergo a slight transformation, which can be carried out in the forest on freshly felled green wood, and this results in a very low added value prior to the treatment and a very high added value after the treatment.

Above all, the work on the flitches and the delignification of boards in this sense optimizes the mechanical property of the wood as a result of the flitch being cut into false flitches.

Thus, the treatment of planks of any widths, and particularly of flitches having a thickness of 10, 16 or 20 cm allows:
The undifferentiated storage of treated wood to be delignified subsequently as a function of demands for plates having a thickness and width that were not determined in advance
A stock of cut wood in the optimal direction of the fiber of the wood to preserve all its mechanical properties

Thanks to the various arrangements of the invention, which were described above, the heat treatment of wood pieces is very substantially improved by the following effects:

The heat is transmitted to the wood pieces by conduction, where the wood pieces are placed on a homogeneous heating plate at a controlled temperature with sufficient inertia.

When the wood pieces are subjected to a pressure exerted by the two plates, the contact with the wood pieces is established on the two faces of the wood.

An additional improvement can be achieved by using a vacuum enclosure.

### Woods of Small Dimension or Twisted and Buckled Wood

Without recourse to the present invention one cannot benefit from carpentry wastes which consist of very short boards that have to be lined up end to end if one wishes to hold them balanced in the stacks. However, uses exist for small pieces of heat stabilized wood, and it is economically nonsensical to connect end-to-end and then again cut pieces, or to use long wood pieces which are expensive, when waste pieces having usable dimensions for these applications cost next to nothing.

It is an additional advantage to be able, according to the invention, to arrange by juxtaposition wood pieces of any dimensions between two plates.

Similarly, buckled or slightly twisted wood is worthless and part of the losses during drying operations, when, in fact, one can use compression of the wood above the glass transition temperature to straighten it.

### Thermo-Stabilization of Plywood and Reconstituted Wood Made of Composite Materials, Composite Materials Pressure+Temperature

The method according to the invention allows three different and complementary approaches:
one starts with a board or plate of plywood wood or reconstituted wood (agglomerated, Oriented Strandboard “OSB,” that is panels of wood fibers, medium density fiberboard and composites, etc.), and one subjects it to a Thermoduralysation® treatment, or
one starts with fragmented wood (ligno-cellulose fibers produced by sawing, platelets, etc.), which one subjects to a Thermoduralysation® treatment to obtain a raw material to fabricate a reconstituted wood whose charge will be Thermoduralysed® wood (powder in polymers and wood-concrete composite materials, wood-plaster, or fibers in chips or particles in the agglomerates),
or, finally, one uses the principle of the thermoregulated press of the method, not only to Thermoduralyser® the charge of wood, but also to have a mold and a pressure means to polymerize the wood and the binder, and form the object by compression during the treatment, and use, if applicable, the enclosure which can be pressurized, and the cooling of the wood, to absorb a polymer by generating a low pressure inside the wood and in the porosity between the juxtaposed and pressed wood fragments.

In the three cases, the first objective is to produce a material on a ligno-cellulose base, which is an agglomerate or a composite combined with a binder, and presents small variations due to shrinkage and swelling in the presence of liquid water or humid air. It is already known that one can achieve this with a torrefied wood as charge, and also with a crosslinked wood which presents more advantageous mechanical properties. The use of wood that has been Thermoduralysed® according to the invention presents further improved properties. The other advantage, for carrying out the method according to the variants 2 and 3, is to have a wettability of the Thermoduralysed® wood which improves the capacity of the ligno-cellulose charge to be impregnated by the binders.

The additional advantage of variant 3 is to be able to use, in addition, the flexibility because the work is done above the transition temperature of the wood and a press is used to apply mechanical stress.

The thermostabilization method according to the invention can be applied to the existing reconstituted woods (plywood, agglomerated woods, OSB, medium density fiberboard, composite wood, etc.).

In the state of the art, the heat treatment, however, faced three types of problems which are solved by the present invention.

The glues and resins used for these reconstituted materials emit gasses that can be toxic or noxious (glues based on urea) or create excess pressures in the furnace, or be polluting. According to the invention, the vacuum enclosure, after evacuation of the contaminating products towards the recovery tanks, allows the treatment of these products.

Due to the effect of heat, or simply the effect of the weight, the boards that rest on the strips tend, according to the state of the art, to bend between strips and become wavy due to the effect of the heat and the weight of the stack, and it may be possible to treat them, because the boards are plastic at high temperature and they do not come out flat, or need to be compressed. According to the invention, these boards of composite material can now be treated by being installed between two heating plates under the required pressure.

Moreover, this also avoids the visual drawback of a trace at the place where the strips were, in the state of the art.

### Variant of the Method for the Fabrication of Reconstituted Thermoduralysed Wood or of Plywood Wood or of Molded Objects Made of Reconstituted Wood

Finally, it is possible to use the treatment according to the invention to impregnate the wood with resins and glues in the cooling phase by making advantageous use of the low pressure in the wood resulting from the cooling itself and the high temperatures reached. The additional advantage is to be able to impregnate a wood that has already been Thermoduralysed®, since one is in the cooling phase, and to benefit from its improved wettability and then use the heating plate as a press. Thus, it is possible to fabricate composite materials from this system.

When producing panels, two plates, of which at least one is heating, form a mold. The plates can be replaced by two semi-shells, of which at least one is heating, the other functioning as a cover and pressing the product with the possibility of injection. Advantageously, a perforated press can be used.

The shells are filled with wood fibers in the form of particles of different sizes and possible shapes, which may originate from sawing, chips or platelets, with optionally binders, which may be thermoplastic or thermohardenable resins, or products originating from the lignin of the wood, which one can use to produce reconstituted wood whose components originate all, or almost all, from the wood.

Moreover, it is particularly advantageous to use the device and the method according to the invention to fabricate a novel material based on compressed and thermoduralysed fibers, without the addition of a binder, and with, optionally, the addition of fibers of another type to reinforce the composite structure, using the free radicals originating from the wood fiber to create bridges between the juxtaposed fibers and make a single macromolecule from them, binding together the entire preparation, and forming a rigid and undeformable assembly, which presents low sensitivity to water, does not swell, and does not become unglued in humid conditions content or following an immersion.

In particular, it is easy to fabricate agglomerated panels using the method between two planar plates.

It is possible to admix, prior to the treatment (or mix during the treatment using an appropriate additional mixing device) glues or resins which will harden or polymerize when the temperature rises.

In comparison to the previous methods, one has the advantage of a thermoregulated press.

The products can be introduced in the vapor or liquid phase at the different temperatures below 230° C. during the cooling phase. The advantage of carrying out the introduction at this stage is that the wood is already thermoduralysed, and one can thus benefit from its wettability to establish more useful bonds between the binder and the wood. The novel advantages that become available according to the invention are, for example,

a vacuum enclosure to have an environment in which one can treat the emanations associated from any solvents used,

the enclosure can be pressurized during the incorporation, and

one can use environments in which one can use molds which, according to the invention, Lanbe thermoregulated presses and which, according to the invention, can be perforated thermoregulated pressures.

As already described above, nothing prevents the use, in addition to the heat and thermoregulation of the press, of a secondary heat source, which can be infrared radiation or microwave radiation, etc.

Indeed, one can accelerate the process by various radiation, microwaves and preferably high-frequencies and even better hyper-frequencies as additional heat sources, although it should be realized that the thermoregulated press remains necessary to maintain a temperature in spite of exothermicity and to lower the temperature at the end of the treatment, so that the radiation accelerates the temperature rise without replacing conduction to maintain and lower the temperature.

Another possibility is to have such an organization of “press molds” which one installs in a thermoregulated bath and maintains without exceeding a temperature between 130 and 140° C. to Thermoduralyze® the wood.

Without synthetic glue, but with resins or extracts based on wood lignin, one can produce reconstituted woods whose charge and binder are both of natural origin, and obtain reconstituted woods which 95-100% of the elements originate from the wood. The advantage is that one can achieve this already without binder by crosslinking, and reinforce the connection with elements originating from lignin, which will make it possible to multiply the chemical bridges.

The direct contact of the plate on the wood in itself can be a means to bar the access of oxygen to the wood, assuming the plates are solid and not porous, and particularly that they are adjusted to the surface of the wood; this setup then makes it possible to carry out such a treatment in the absence of a confining enclosure, and ipso facto in the absence, in the nonexisting enclosure, of nitrogen or water or carbon dioxide to render inert the gas medium in contact with the water, because, in the end, the quantity of this gas medium is negligible. The phenomenon is accentuated by the increase in the temperature of the wood, which creates an excess pressure of gases originating from the wood, so that the small gas volume existing between the plate and the wood resulting from an imperfect adjustment is at an excess pressure compared to the atmosphere during the heating phase, while the opposite is the case during the cooling phase. A quantity of air available for combustion is not zero, but it can remain marginal, and the combustion at the level of the surface can be sufficiently marginal to be eliminated by the 4-face planing after the treatment.

However, it is preferred for the treatment to be carried out in a vacuum enclosure, and in this case, the enclosure need not be rendered inert by nitrogen or carbon dioxide or water, instead it is the vacuum which guarantees that the oxygen quantity remains sufficiently small to prevent significant combustion.

### Thermoduralysis® of the Wood—Thermoduralysed® Wood

It is known that wood can be modified due to the effect of a high temperature by different known methods whose result is to permanently modify certain properties of the wood.

This objective is reached in a more or less satisfactory manner according to the methods using the temperature curve or the physicochemical conditions that characterize each method and allow the use of the transformation reactions inside the wood that lead to the formation of chemical bridges (covalent bonds, crosslinking) between the macroscopic chains of the constituents of the wood.

In general, one uses the term controlled pyrolysis, but it would be more correct to speak of controlled thermolysis, because the reactions do not occur as a result of the action of the fire, but in the absence of oxygen due to the effect of the temperature.

However, it is known that wood is a composite material consisting essentially of three types of polymers: hemicelluloses, lignins, and cellulose, from the most fragile to the least sensitive to the effective temperature. A controlled thermolysis cleaves primarily the hemicelluloses, and it starts to modify the lignin. The byproducts of the thermolysis, essentially the free radicals, would then condense and polymerize on the lignin chains, and it is known that these reactions create a new “pseudo-lignin” which is more hydrophobic and more rigid than the initial lignin.

The invention makes it possible to improve the heat treatment of wood and to obtain the following advantages:

### Quality:

For the past 10 years, the quality of crosslinked wood has been good, but it has not progressed, in spite of being deemed insufficient for any structural use.

The measurements of mechanical losses have an enormous standard deviation, because the mechanical losses for pine vary from 20% to 60% depending on the samples, while the biological resistance has a maximum of 45% instead of 90% if one increases to 150° C.

The theoretical analysis of the method shows that it would be possible to decrease this heterogeneity and to obtain a superior performance by attacking the roots of the problem to obtain a lower thermal inertia, vary all the parameters of the kinetics, use a principle that involves no possible difference in behavior because of the geographic position inside the treatment enclosure.

One can not only limit the mechanical losses, but, starting from a large volume and compacting it, one can also improve the mechanical performances, which makes it possible to go further in the treatment of the stability of the imputrescibility:
drying of optimal quality and rapidity, followed in the same process (without intermediate manipulation or cooling) by Thermoduralysation® because the furnace has the characteristics of a vacuum dryer, and consequently it is not logical to carry out the programs after the other, since the heat from drying has started the work of heating the wood
Thermoduralysation® of several species or thicknesses of wood in the same furnace, because one can regulate independently several zones of heating plates
Thermoduralysation® of thicker wood: however, the Thermoduralysation® of planks, and particularly of flitches having a thickness of 20 cm, would make possible:
a stock of undifferentiated Thermoduralysed® wood, to then delignify as a function of the demands for boards having a thickness and width which were not determined in advance
a stock of wood cut in the optimal direction of the fiber of the wood to preserve all its mechanical properties
homogeneous mechanical stress over the entire surface of the wood throughout the heating
finally, an essential factor, an incomparable potential in terms of quality and quality control and traceability, because:
all the factors of inertia and random events (circulation of the flows and heat exchange between the flow and the wood, which depend on the relative moisture content of the flow and of the wood) have been eliminated
complete spatial homogeneity of the heat additions
perfect monitoring by means of a highly developed system of probes
superior absence of oxygen to nitrogen absence, because the vacuum also evacuates the oxygen produced by the wood
very strong decrease of the risk of collapse, because the vacuum and the pressure accelerate the exit of water.

### Profitability:

One can divide by two, or even much more, the treatment time.

One can replace the purchase of expensive woods by woods of zero or negative cost, because they have had been chemically treated, if one wishes to decontaminate them during the treatment.

One can treat woods of small size or buckled woods.

One can eliminate the nitrogen (8% of the cost of treatment) and achieve treatment energy savings (also 8% of the cost of treatment) by recovering the cooling energy.

One can use flitches for an undifferentiated storage and a higher added value.

One can increase the range of reconstituted woods.

One can start with green wood.

One can achieve an energy saving (at least 50%), because the heating liquid is stored in an adiabatic enclosure between two heaters and the cooling energy can be used during opposite phases for the drying and for the temperature increase of another cycle.

To achieve all these results, which have not been obtained in the past 10 years, the invention, after having analyzed the potentials of the wood, carries out a combination of actions in the determined temperature ranges making advantageous use of the properties of this complex composite material.

When the wood is treated at a glass transition temperature and when the wood, according to the invention, is mechanically stressed by a homogeneous pressure exerted on the wood by the heating plates, this prevents a relaxation of the external edge of the wood, which instead will be under compression, and this thus avoids the disadvantage of splitting the wood during the pass through the glass transition temperature. In this regard, the invention makes it unnecessary to use a temperature plateau at the glass transition temperature or at another temperature.

Another substantial advantage of the invention is that the decontamination of the wood to be recycled is impossible with the methods that are generally used, but it is possible with the method and the installation of the invention.

The problems of crosslinking pine show that it is difficult to treat resin-impregnated wood. It is not possible to extract optionally all the dangerous contaminant products from the wood, all the products have to be conveyed to a tank without loss during transport.

Here on the other hand everything that comes out of the wood can be conveyed.

Moreover, one can set up conditions that are much more effective for the extraction thanks to the combined use of the three parameters: mechanical crushing in the glass phase, temperature and low pressure in the enclosure, without forgetting the guidance effect of the plates which prevent any slightly heavy or viscous material from falling due to gravity to the bottom of the tank.

While it is true that the extraction from the wood is carried out by the effective heat, a liquid part drops to the bottom of the tank, and a volatile part mixes with the air: the invention solves this problem because one has a low pressure which concentrates the entire quantity of juices, gaseous or liquid, originating from the wood, which can be stored in an appropriate external tank which has been approved for the storage of these dangerous products.

For products whose rheology requires them to be in the liquid or gaseous form, and to present low viscosity at high temperature, the decontamination starts with the drying, but it is completed only in the glass phase: glass phase allows the crushing of the wood and decrease of the pore space, creating ipso facto a very strong excess pressure in the wood and a very high thermal conductivity, which will allow the extraction of all the products.

### Cooling: Recovery of Heat

The problems of heating by air flow and the problems pertaining to the cooling water prevent the use of the heat energy of the wood, which one cools to heat another charge: a heat pump would be needed to dry and recover the latent transformation heat, and this would be more expensive than the recovery of heat it would allow.

On the contrary, with a primary circuit in the plates that exchange with exchanger with a secondary circuit, it is possible to use the energy of a lot of hot wood which one has to cool before taking it out into the air (between 80° C. and 100° C., the wood ignites spontaneously in the air) to heat another lot of wood located in another cell with a very high energy impact, since the energy to cool wood from 250° C. to 80° C. is, disregarding the internal chemical energies and the energies from the change in pressure, equal to the energy required to raise the temperature of an equivalent weight of wood, from 80° C. to 250° C.

The force is applied to the entire charge, one prevents the phenomena associated with the battening, achieving both mechanical and thermal homogeneity. Thanks to the thermal inertia of the heating plates, in the absence of complicated heat transfer events, it becomes possible, for the first time to date, to ensure a perfect homogeneity of the contribution of addition of heat to the wood. One has simultaneously absence of battening, absence of temperature difference at the different points of the furnace, absence of a difference in speed, absence of different degrees of moisture content, absence of a difference of the coefficient of exchange with the skin of the wood, and absence of a difference in evaporation in the limited layer.

Another advantage is to carry out, in the same process, the drying of the wood and its Thermoduralysation® without having to take the dried wood to the outside in the meantime.

One benefits, first, from the water inside the green wood to prevent the previous fatigue of the membranes of the cells, due to the natural heating of the wood which leads to an internal pressure in the cells that is greater than the pressure of the porosity which has been emptied of its liquid.

On the contrary, at the time of placement in the furnace, one can benefit from the moisture content of the wood to compress it without exerting a mechanical disequilibrium on the membranes of the cell, while benefiting, on the contrary, from the pressure equilibrium which establishes itself at the level of the membrane, due to the presence of liquid outside the cells (moisture content of the wood in the porosity of the wood) and in the interior of the cells (constitutive water). In addition, the presence of water in the starting wood allows a very good thermal conductivity inside the wood at the start of the drying operation, which allows a very rapid and homogeneous increase in the temperature into the core of the wood at a much higher temperature than the one used traditionally for vacuum drying, putting to advantageous use the mechanical pressure exerted in the wood to shift the boiling point upward.

The ideal is to achieve, if possible, a temperature of plasticity of the wood before vaporization or, in any case, to approach it as much as possible, to avoid the excess pressures connected with the vaporization of water that cannot escape outward due to inadequate kinetics, resulting in mechanical fatigue and ultimately collapse events inside the wood. The collapse takes place when the pressure difference between the exterior and the interior of a cell, or a pocket of porosity connected with the heterogeneity of the wood (due to its constitution or its history) is greater than the capacity of resistance of the membrane of the cell (microscopic version) or of the surface of the pocket (macroscopic version).

The advantage of being able to exert a uniform pressure over the entire surface of the wood is to be able to generate an equilibrium pressure at a pressure above atmospheric pressure. Heat being transmitted through the exterior allows the vaporization to start from the exterior with a strong pressure differential between the interior of the wood—at a pressure above atmospheric pressure—and a pressure outside the wood piece—in an enclosure maintained at a pressure that is below atmospheric pressure. This allows a very rapid evacuation of the steam to the exterior of the piece.

However, the kinetic principle is to have a sufficiently rapid evacuation so that no vapor accumulates. Since, for drainage, one must avoid “clogging” and thus have an increasingly faster evacuation rate as one moves towards the execution, namely the surface outside the wood. However, the evacuation force which is exerted on the liquids and the gases to propel them to the execution phase is proportional to the difference in pressure between the interior and the exterior of the wood, when one can exert an excess pressure through the intermediary of the wood itself on the interstitial water.

When the wood is compressed in the thermoregulated press, the force is applied to the entire charge. Thus, one prevents events associated with the battening, and one achieves both mechanical and thermal homogeneity. Thanks to the thermal inertia of the heating plates, in the absence of complicated heat transfer events, it becomes possible, for the first time to date, to ensure a perfect homogeneity of the addition of heat to the wood. Thus one has, simultaneously, absence of battening, absence of temperature difference between the points of the furnace, absence of a difference in speed, absence of a difference in degree of moisture content, absence of a difference in coefficient of exchange with the skin of the surface, and absence of a difference in evaporation in the limited layer.

Another advantage is being able to carry out, in the same process, the drying of the wood and its Thermoduralysation® without having to take the dried wood to the outside in the meantime.

One benefits, first, from the water inside the green wood preventing the previous fatigue of the membranes of the cells, due to the natural heating of the wood which leads to an internal pressure in the cells that is greater than the pressure of the porosity which has been emptied of its liquid.

On the contrary, at the time of placement in the furnace, one can benefit from the moisture content of the wood to compress it without exerting a mechanical disequilibrium on the membranes of the cell, while benefiting, on the contrary, from the pressure equilibrium which establishes itself at the level of the membrane, due to the presence of liquid outside the cells (moisture content of the wood in the porosity of the wood) and in the interior of the cells (constitutive water). In addition, the presence of water in the starting wood allows a very good thermal conductivity inside the wood at the start of the drying operation, which allows a very rapid and homogeneous increase in the temperature into the core of the wood at a much higher temperature than the one used traditionally for vacuum drying, putting to advantageous use the mechanical pressure exerted in the wood to shift the boiling point upward.

Other characteristics and advantages of the present invention will become apparent from the following description of an embodiment and of a variant of an installation according to the invention and their functioning. This description is made in reference to the drawings, in which:

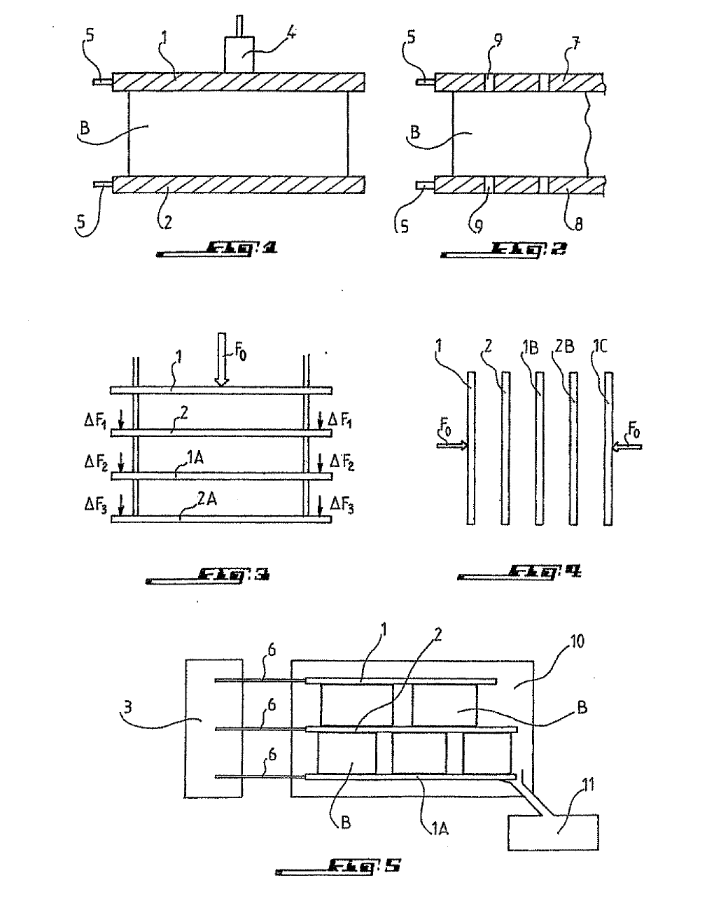

FIG. 1 shows a transverse cross section, the basic arrangement of an installation according to the invention;

FIG. 2 shows a variant of the arrangement of FIG. 1;

FIG. 3 shows the principle of the application of a compression force on a set of horizontal plates according to the invention;

FIG. 4 shows the principle of the application of a compression force to a set of vertical plates according to the invention;

FIG. 5 is a schematic representation of an installation according to an embodiment of the invention.

According to the invention, an installation for treating solid or reconstituted wood by the application of moderate or high temperature comprises at least 1 thermoregulated plate 1, which allows, by conduction, the heating of the wood B placed between the plates 1 and 2, where the plate 2 is preferably thermoregulated or it can provide simple mechanical support. The temperature of said plates themselves is controlled precisely in terms of time and intensity by a regulation means that is part of the device that supplies thermoregulated heat-conducting fluid 3. The device 3 comprises a heating component and a cooling component, as well as, besides the regulation means, sensors intended to measure the temperature at different places of the installation, notably on the plates, and also heat sensors placed at the end of a board in the core of the wood, and valves or other adjustable means that allow the flow of the heat-conducting fluid to be varied according to the instantaneous needs of the ongoing treatment, where the needs are determined by the regulation means.

FIG. 1 shows the basic arrangement of an installation according to the invention. It comprises, besides the plates whose number can vary from one installation to another, a jack 4, or, optionally, several jacks 4 distributed over the upper surface of the upper plate 1, and exerting, during the treatment of a lot of wood B, a pressure intended to generate a homogeneous compression stress on the wood place between the plates 1, 2.

Advantageously, the metal plates can also be used as emitting antennas arranged in parallel to emit electromagnetic radiation, particularly high-frequency or hyper-frequency radiation, to increase the temperature very rapidly in the wood piece, homogeneously between the core and the edge, which is particularly advantageous for thick pieces.

A device exists which allows the total weight of the lot to be treated to be measured and recorded at all times during the treatment.

In FIGS. 1, 2 and 5, the wood is given consistently the reference “B.” This unique reference emphasizes that one of the advantages of the present invention is that its application and even its effectiveness are not limited to a certain type of new or recovered wood, nor to any particular shapes or dimensions of the wood pieces placed between the plates. The wood pieces can, incidentally, also be pieces of irregular shape.

Each of the plates 1, 2 is provided with two connections 5 for the connection of the plates to the device 3 for supplying a thermoregulated heat-conducting fluid, and thus the installation of a circuit for the heat-conducting fluid. According to the chosen embodiment, each plate can be connected individually to an individually assigned and regulated circuit, just as all the plates can be connected to a single circuit of the device 3. Other arrangements, forming intermediate solutions between these two extreme solutions, are also conceivable, without going beyond the principle of the present invention.

FIG. 1 also shows plates having solid surfaces, while FIG. 2 shows plates 7, 8 having surfaces perforated by passages 9. It does not matter which one of these two types of plates is chosen, the duration for which the openings of the passages 9 have dimensions and shapes such that the wood does not preserve imprints after the treatment.

When the installation according to the invention comprises more than two horizontally arranged plates, and can thus treat two or more layers of wood, the term “layer of wood,” designating any set of wood pieces placed between two plates, the pressure exerted on the layers of wood increases from the upper layer towards the lower layer due to the force F0 generating the nominal pressure being increased, from plate to plate, by an additional force ΔF1, ΔF2, ΔF3, etc., which depends on the weight of the respective layer of wood. FIG. 3 shows this schematically.

To compensate for the increasing pressure, the installation according to the invention can be provided with counter-regulation means, individually for each plate, allowing the exertion on each plate of forces oriented against the force F0.

Advantageously, these counter-regulation means are actuated by an adjustable pressure source which also actuates the jack 4. The regulation of the jack 4 and of the counter-regulation means can be carried out only at the beginning of the treatment, but also at intervals, which may be regular or irregular, during the treatment to take into account reductions in the weight and the volume of the wood, which occur due to the treatment, and to thus maintain as constant as possible a pressure on the layers of wood, and as equal a pressure as possible, from one layer to the other.

When the plates are arranged vertically, as shown in FIG. 4 the force F0 is applied to the two end plates. The force F0 is then advantageously, but not necessarily, changed during the treatment to take into account reductions in volume that occur due to the treatment.

The plates of the installation according to the invention are heated to and maintained at the desired temperature, and then cooled to a new temperature, by any appropriate management and thermal control means. This means can be adapted to the treatment, to the quantity of wood to be treated, and to the type of heat-conducting fluid used.

FIG. 5 shows the plates of an installation, which are arranged according to an embodiment of the invention. The plates are arranged in an enclosure 10 inside which the treatment climate can be varied in different ways, notably insofar as its temperature is concerned, which is independent of the temperature of the plates or the temperatures of each of the plates, and its pressure. In general, the pressure will be that of an industrial vacuum or a partial vacuum.

During some wood treatments, for example, during the treatment of recovered wood, products contained in the wood are released and collected at the bottom of the enclosure 10. To prevent these products from being reintroduced into the wood, for example, at the time of the elimination of the vacuum, the products that are collected, and generally liquid, are conveyed towards a tank 11 or, optionally, towards several tanks 11, each one being assigned to a particular product.

1-10. (canceled)

11. A method for treating wood, comprising:
arranging wood pieces in a vacuum vessel and in contact with a thermoregulated conductive press having a regulated temperature as a function of time;
heating the wood pieces by conduction in a temperature cycle having a maximum temperature between 100° C. and 280° C. in the vacuum vessel, while controlling pressure within the vacuum vessel;
extracting and conveying gases and liquids extracted from the wood pieces to a recovery tank; and
cooling the wood pieces.

12. The method according to claim 11, wherein the temperature of the thermoregulated conductive press is lowered, during the cooling, with a latency time of less than 10 minutes, to lower temperature of the wood pieces by 2° C.

13. The method according to claim 11 including decontaminating wood pieces containing toxic chemical products, by heating at a maximum temperature of the temperature cycle between 150° C. and 190° C., and higher than the glass transition temperature of the wood pieces and lower than a temperature of crosslinking of the wood pieces.

14. The method according to claim 11, wherein the maximum temperature of the temperature cycle is between 150° C. and 280° C. for selective emission of natural extracts from the wood pieces.

15. The method according to claim 11 including, during the treating, applying force to the wood pieces with the thermoregulated conductive press to the wood pieces according to a pressure curve as a function of time.

16. The method according to claim 11 including applying electromagnetic radiation to increase the temperature in the wood pieces very rapidly, and relatively homogeneously, between cores and edges of the wood pieces.

17. The method according to claim 11 including first, vacuum pumping of the vacuum vessel, second, controlling the temperature of the wood pieces to produce evacuated gases and liquids and generate an excess pressure in the wood pieces, and, third, compressing the wood pieces at a temperature beyond the glass transition temperature of the wood pieces, decreasing pore space of the wood pieces.

18. The method according to claim 11 including heating the wood pieces to a temperature above melting temperature of products which are extracted from the wood pieces and conveying the products through a circuit kept sufficiently hot to preserve fluidity and ensure conveyance of the products to the recovery tank.

19. The method according to claim 11 including extracting toxic preservative products contained in the wood pieces due to previous impregnation and conveying the toxic preservative products to the recovery tank.

20. An apparatus for treating wood pieces comprising:
a tank for the recovery of extracted products extracted from the wood pieces;
a circuit for conveyance of the extracted products to the tank;
a vacuum enclosure enclosing a thermoregulated conductive press for heating and cooling the wood pieces placed in contact with the press, according to a temperature cycle having a maximum temperature between 100° C. and 280° C.; and
a system controlling, in terms of time and intensity, pressure inside the enclosure, and conveying gases or liquids extracted from the wood pieces, through the conveyance circuit, to the tank.

21. The apparatus according to claim 20 including means for maintaining the conveyance circuit at a sufficient temperature to prevent solidification of the extracted products for conveyance to the recovery tank.

22. The apparatus according to claim 20 including condensing means at the tank for condensing gases extracted from the wood pieces.

23. The apparatus according to claim 20 including a refrigeration source and a heat exchanger for the refrigeration source for lowering the temperature of the wood press by 2° C. in 10 min in a cooling phase.

24. The apparatus according to claim 20 comprising a generator of electromagnetic radiation for raising the temperature of a wood piece very rapidly, and relatively homogeneously, between core and edge of the wood piece.

25. The apparatus according to claim 24, wherein the thermoregulated conductive press includes an emitting antenna for emitting electromagnetic waves.

26. The apparatus according to claim 20 comprising at least one heat exchanger dedicated to the thermoregulated conductive press.

27. The apparatus according to claim 26 including a network of secondary heat exchangers for heat exchange with the heat exchanger.

28. The apparatus according to claim 20, wherein the thermoregulated press is porous or perforated.

29. The apparatus according to claim 20 including means for measuring parameters of each temperature cycle, the temperature cycle at edge and at core of at least one of the wood pieces, compression exerted on at least one of the wood pieces by the thermoregulated press, and total weight of one of the enclosure and the tank to determine total weight of the extracted products which are conveyed during treating of the wood pieces.

30. The apparatus according to claim 20 comprising a plurality of thermoregulated conductive presses stacked horizontally or vertically, and connected to respective means for controlling pressure applied to the wood pieces during treating of the wood pieces.

31. The apparatus according to claim 20 including a plurality of tanks, and respective conveyance circuits for each tank, and conveyance circuits controllable to direct the extracted products to different tanks during different phases of a temperature cycle.
